(19) United States
(12) Patent Application Publication
(10) Pub. No.: US 2026/0030216 A1
(43) Pub. Date: Jan. 29, 2026

(54) SYSTEMS AND METHODS TO HANDLE DEPENDENT DATA, CONFLICTING DATA, OR METADATA OPERATIONS ON A DUAL COPY CROSS-SITE STORAGE SYSTEM WITH SIMULATANEOUS READ-WRITE ABILITY ON EACH COPY

(71) Applicant: NetApp, Inc., San Jose, CA (US)

(72) Inventors: Akhil Kaushik, San Jose, CA (US); Anoop Vijayan, Bangalore (IN); Dhruvil Shah, Bangalore (IN)

(73) Assignee: NetApp, Inc., San Jose, CA (US)

(21) Appl. No.: 18/785,773

(22) Filed: Jul. 26, 2024

(51) Int. Cl. G06F 16/176; G06F 16/182

(52) U.S. Cl. CPC G06F 16/1774; G06F 16/184

(57) ABSTRACT

The present storage solution provides an order of operations of a computer-implemented method that includes implementing a primary-First principle with a first data Op received by the primary storage site being executed on the primary storage site and then replicated to the secondary storage site and a second data Op received by the secondary storage site being first replicated to the primary storage site. The method further includes acquiring overlap write manager (OWM) lock locally on the primary storage site for the first data Op if there are no conflicting ops that are already inflight working on an overlapping range, sending the first data Op to a file system of the primary storage site to modify the file system as per primary-first principle, and suspending any new Ops from the primary storage site that have an overlapping range that overlaps with a range of the first data Op.

### FIELD

Various embodiments of the present disclosure generally relate to a dual copy multi-site distributed data storage systems. In particular, some embodiments relate to systems and methods to handle dependent data, conflicting data, and metadata operations during bidirectional replication between primary and secondary storage sites of the dual copy multi-site distributed data storage systems.

### BACKGROUND

Multiple storage nodes organized as a cluster may provide a distributed storage architecture configured to service storage requests issued by one or more clients of the cluster. The storage requests are directed to data stored on storage devices coupled to one or more of the storage nodes of the cluster. A fully symmetric storage solution allows simultaneous read-write access to both a primary copy of data on a primary storage site and a secondary copy of the data on a secondary storage site. While allowing read-write access on both sides, a fully symmetric storage solution must guarantee consistency of both data and metadata to both a primary copy of data on a primary storage site and a secondary copy of the data on a secondary storage site. If dependent operations are not serialized, the dependent operations can execute in a different order on each copy, leading to divergence, or inconsistencies between the two copies. Typical ways of achieving serialization using locks can lead to deadlocks, a state where two or more operations are unable to proceed because each is waiting for the other to release resources.

### SUMMARY

In one example, the present storage solution provides an order of operations of a computer-implemented method that includes establishing bi-directional synchronous replication between one or more members of a first consistency group (CG1) of a primary storage site and one or more members of a second consistency group (CG2) of a secondary storage site with each storage site having read/write access. The method includes implementing a primary first principle with a first data Op received by the primary storage site being executed on the primary storage site and then replicated to the secondary storage site and a second data Op received by the secondary storage site being first replicated to the primary storage site first and then executed locally on the secondary storage site. The method further includes acquiring overlap write manager (OWM) lock locally on the primary storage site for the first data Op if there are no conflicting ops that are already inflight working on an overlapping range, sending the first data Op to a file system of the primary storage site to modify the file system as per primary-first principle, and suspending any new Ops from the primary storage site that have an overlapping range that overlaps with a range of the first data Op.

Other features of embodiments of the present disclosure will be apparent from accompanying drawings and detailed description that follows.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 is a block diagram illustrating an environment in which various embodiments may be implemented.

FIG. 2 is a block diagram illustrating an environment having potential failures within a multi-site distributed storage system in which various embodiments may be implemented.

FIG. 3 is a block diagram of a multi-site distributed storage system according to various embodiments of the present disclosure.

FIG. 4 is a block diagram illustrating a storage node in accordance with an embodiment of the present disclosure.

FIG. 5 is a block diagram illustrating the concept of a consistency group (CG) in accordance with an embodiment of the present disclosure.

FIG. 6A is a CG state diagram in accordance with an embodiment of the present disclosure.

FIG. 6B is a volume state diagram in accordance with an embodiment of the present disclosure.

FIGS. 7A and 7B illustrate a flow diagram for a computer-implemented method for a delegation technique (e.g., delegation process) to handle dependent operations for a symmetric distributed storage system having Active/Active bi-directional synchronous replication with concurrent read/write access to both copies of data on primary and secondary storage sites in accordance with an embodiment of the present disclosure.

FIG. 8 illustrates a flow diagram for a computer-implemented method of primary first sequential split operations for a symmetric distributed storage system having Active/Active bi-directional synchronous replication in accordance with an embodiment of the present disclosure.

FIG. 9 illustrates a flow diagram for a computer-implemented method of primary first sequential split operations for a data op received on secondary storage site for a symmetric distributed storage system having Active/Active bi-directional synchronous replication in accordance with an embodiment of the present disclosure.

FIGS. 10A and 10B illustrate conflict resolution techniques for data op 1 (e.g., W1) arriving on the primary storage site and a concurrent data op 2 (e.g., W2) arriving on the secondary storage site with both of the data ops operating on an overlapping byte range in accordance with an embodiment of the present disclosure.

FIG. 11 illustrates a flow diagram for a computer-implemented method of a primary side data flow for bidirectional replication of Inode dependent operations for a symmetric distributed storage system having Active/Active bi-directional synchronous replication in accordance with an embodiment of the present disclosure.

FIGS. 12A and 12B illustrate a flow diagram for a computer-implemented method of a secondary side data flow for bidirectional replication of Inode dependent operations for a symmetric distributed storage system having Active/Active bi-directional synchronous replication in accordance with an embodiment of the present disclosure.

FIG. 13 illustrates an example computer system in which or with which embodiments of the present disclosure may be utilized.

FIG. 14 is a block diagram illustrating a cloud environment in which various embodiments may be implemented (e.g., virtual storage nodes of a primary storage site, a secondary storage site, and a tertiary storage site).

FIG. 15 is a block diagram illustrating a virtualized environment in which various embodiments may be implemented (e.g., virtual storage nodes of a primary storage site, a secondary storage site, and a tertiary storage site).

### DETAILED DESCRIPTION

Systems and methods are described for a fully symmetric storage solution that allows simultaneous read-write access to both a primary copy and a secondary copy of data. The storage solution handles dependent data, conflicting data, and metadata operations during bidirectional replication between primary and secondary storage sites of the dual copy multi-site distributed data storage systems.

The fully symmetric storage solution provides application-granular zero recovery point objective (ZRPO) data protection that prevents any data loss and zero recovery time objective (ZRTO) transparent failover that provides instant recovery in the event of various potential faults for a primary storage site, a secondary storage site, and communication links between the primary and secondary storage sites. Concurrent read/write access to both copies in a symmetric Active/Active storage system is facilitated by bi-directional synchronous replication. This means that any write operation (WRITE op) initiated on a primary copy of a primary storage site is synchronously replicated to the secondary copy on a secondary storage site before a client receives an acknowledgment (ACK). Similarly, a WRITE op initiated on secondary copy is synchronously replicated to the primary copy before the client receives an ACK. This bi-directional sync replication ensures that both copies are always up-to-date and consistent with each other.

Despite the advantages of bi-directional synchronous replication in a symmetric Active/Active system, this storage solution presents challenges due to data management operations that need to be replicated between the primary and secondary storage sites of the dual copy multi-site distributed data storage systems.

While allowing read-write access on both sides, the storage solution must guarantee the consistency and fidelity of both data and metadata during bidirectional replication between the primary and secondary storage sites. This means that the integrity and accuracy of the data and metadata must be maintained during the replication process.

In terms of serialization of dependent operations, if the dependent operations are not serialized, then the dependent operations can execute in a different order on each copy, leading to divergence, or inconsistencies between the two copies. Typical ways of achieving serialization using locks can lead to deadlocks, a state where two or more operations are unable to proceed because each is waiting for the other to release resources.

For symmetric performance profile, conflicts are bound to occur when data and metadata operations are serialized from both ends in an Active/Active mirroring storage solution. In such cases, it becomes necessary to prioritize operations from one endpoint over the other to resolve these conflicts while still maintaining consistent throughput and latency performance profiles for both storage systems.

In one example, the primary storage site and secondary storage site are located in relatively close proximity (e.g., less than 100 km, proximity based on round trip time guarantees for synchronous replication datasets) and a tertiary storage site is located at a greater distance. In another example, one or more of the storage sites (e.g., one storage site, two storage sites, three storage sites) can be located in a private or public cloud, accessible (e.g., via a web portal) to an administrator associated with a managed service provider and/or administrators of one or more customers of the managed service provider, includes a cloud-based, monitoring system provided that network connectivity is suitable for synchronous replication between the two synchronous replicated copies. Furthermore, other combinations for the storage sites are possible, for example, one storage site on premise and two storage sites in the cloud and other such variants. The three site topology is applicable to cloud-resident workloads and datasets as well. For a fully cloud resident dataset, two sites can be in the same region (e.g., same availability zone (AZ) or different AZs with sync replication being a limit to a distance between the two sites) and the third site can be in a different region (e.g., a long distance dataset copy) or even an on premise data center. Availability zones (AZs) are isolated data centers located within specific regions in which public cloud services originate and operate. Cloud computing businesses typically have multiple worldwide availability zones. A cloud-resident workload is an application, service, capability, or a specified amount of work that consumes cloud-based resources (e.g., computing or memory power). Databases, containers, microservices, VMs, and Hadoop nodes are examples of cloud workloads.

In one embodiment, cross-site high availability is a valuable addition to cross-site zero recover point objective (RPO) that provides non-disruptive operations even if an entire local data center becomes non-functional based on a seamless failing over of storage access to a mirror copy hosted in a remote data center. This type of failover is also known as zero RTO, near zero RTO, or automatic failover. A cross-site high availability storage when deployed with host clustering enables workloads to be in both data centers.

Given that more workloads are moving to a cloud environment and many customers deploy hybrid cloud, applications will also demand these same features in the cloud including cross-site high availability, planned failover, planned migration, etc.

As such, embodiments described herein seek to improve the technological processes of a fully symmetric storage solution that allows simultaneous read-write access to both a primary copy and a secondary copy of data and also ensures proper handling of dependent operations, conflicting operations, and metadata operations. Various embodiments of the present technology provide for a wide range of technical effects, advantages, and/or improvements to multi-site distributed storage systems and components. The present storage solution provides a delegation technique for handling dependent operations in a bidirectional Active/Active storage system. In this approach, a server (e.g., primary storage site) delegates the management of specific regions of a file to a client (e.g., secondary storage site). This delegation allows the secondary storage site to have exclusive access, eliminating the need to explicitly coordinate with the primary storage site on a per op basis. This primary storage site-issued delegation-protocol based design allows both copies to establish a negotiated understanding of non-overlapping regions in a stretched storage object.

In another embodiment, for a dual-copy storage system of the present design, operations are performed in a sequential manner and on a primary copy of data first. In case of conflicts, the requests landing on a primary copy of data on a primary storage site are prioritized over those received by a secondary copy of data on a secondary storage site.

In the following description, numerous specific details are set forth in order to provide a thorough understanding of embodiments of the present disclosure. It will be apparent, however, to one skilled in the art that embodiments of the present disclosure may be practiced without some of these specific details. In other instances, well-known structures and devices are shown in block diagram form.

### Terminology

Brief definitions of terms used throughout this application are given below.

A “computer” or “computer system” may be one or more physical computers, virtual computers, or computing devices. As an example, a computer may be one or more server computers, cloud-based computers, cloud-based cluster of computers, virtual machine instances or virtual machine computing elements such as virtual processors, storage and memory, data centers, storage devices, desktop computers, laptop computers, mobile devices, or any other special-purpose computing devices. Any reference to “a computer” or “a computer system” herein may mean one or more computers, unless expressly stated otherwise.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure, and may be included in more than one embodiment of the present disclosure. Importantly, such phrases do not necessarily refer to the same embodiment.

### Example Operating Environment

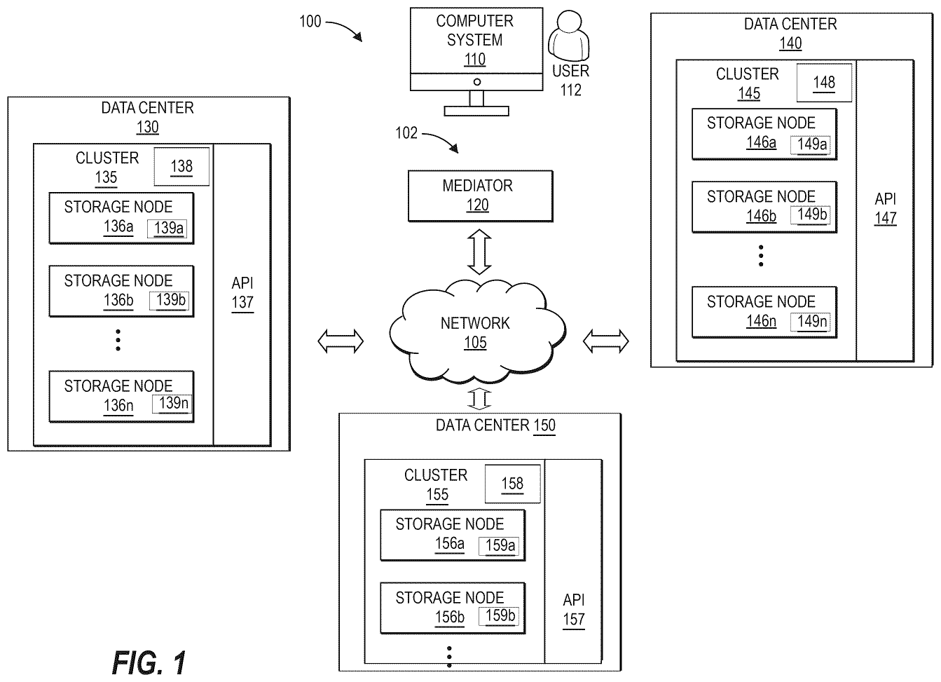

FIG. 1 is a block diagram illustrating an environment 100 in which various embodiments may be implemented. In various examples described herein, an administrator (e.g., user 112) of a multi-site distributed storage system 102 having clusters 135, 145, and optional cluster 155 or a managed service provider responsible for multiple distributed storage systems of the same or multiple customers may monitor various operations and network conditions of the distributed storage system or multiple distributed storage systems via a browser-based interface presented on computer system 110. The distributed storage system 102 provides a fully symmetric storage solution that allows simultaneous read-write access to both the primary and secondary copies of the data while ensuring consistency between different clusters for dependent operations, conflicting operations, and metadata operations.

In the context of the present example, the multi-site distributed storage system 102 includes a data center 130, a data center 140, an optional data center 150, and optionally a mediator 120. The data centers 130, 140, 150, the mediator 120, and the computer system 110 are coupled in communication via a network 105, which, depending upon the particular implementation, may be a Local Area Network (LAN), a Wide Area Network (WAN), or the Internet.

The data centers 130, 140, and 150 may represent an enterprise data center (e.g., an on-premises customer data center) that is owned and operated by a company or the data center 130 may be managed by a third party (or a managed service provider) on behalf of the company, which may lease the equipment and infrastructure. Alternatively, the data centers 130, 140, and 150 may represent a colocation data center in which a company rents space of a facility owned by others and located off the company premises. The data centers are shown with a cluster (e.g., cluster 135, cluster 145, cluster 155). Those of ordinary skill in the art will appreciate additional IT infrastructure may be included within the data centers 130, 140, and 150. In one example, the data center 140 is a mirrored copy of the data center 130 to provide non-disruptive operations at all times even in the presence of failures including, but not limited to, network disconnection between the data centers 130 and 140 and the mediator 120, which can also be located at a data center. The cluster 155 of optional data center 150 can have an asynchronous relationship, synchronous relationship, or be a vault retention of the cluster 135 of the data center 130.

Turning now to the cluster 135, it includes a configuration database 138, multiple storage nodes 136a-n each having a respective mediator agent 139a-n, and an Application Programming Interface (API) 137. In the context of the present example, the multiple storage nodes 136a-n are organized as a cluster and provide a distributed storage architecture to service storage requests issued by one or more clients (not shown) of the cluster. The configuration database may store configuration information for a cluster. A configuration database provides cluster wide storage for storage nodes within a cluster. The data served by the storage nodes 136a-n may be distributed across multiple storage units embodied as persistent storage devices, including but not limited to HDDs, SSDs, flash memory systems, or other storage devices. In a similar manner, cluster 145 includes a configuration database 148, multiple storage nodes 146a-n each having a respective mediator agent 149a-n, and an Application Programming Interface (API) 147. In the context of the present example, the multiple storage nodes 146a-n are organized as a cluster and provide a distributed storage architecture to service storage requests issued by one or more clients of the cluster. Turning now to the optional cluster 155, it includes a configuration database 158, multiple storage nodes 156a-b each having a respective mediator agent 159a-b, and an Application Programming Interface (API) 157.

The API 137 may provide an interface through which the cluster 135 is configured and/or queried by external actors (e.g., computer system 110, data center 140, the mediator 120, clients). Depending upon the particular implementation, the API 137 may represent a Representational State Transfer (REST)ful API that uses Hypertext Transfer Protocol (HTTP) methods (e.g., GET, POST, PATCH, DELETE, and OPTIONS) to indicate its actions.

Depending upon the particular embodiment, the API 137 may provide access to various telemetry data (e.g., performance, configuration, storage efficiency metrics, and other system data) relating to the cluster 135 or components thereof. As those skilled in the art will appreciate various other types of telemetry data may be made available via the API 137, including, but not limited to measures of latency, utilization, and/or performance at various levels (e.g., the cluster level, the storage node level, or the storage node component level).

In the context of the present example, the mediator 120, which may represent a private or public cloud accessible (e.g., via a web portal) to an administrator associated with a managed service provider and/or administrators of one or more customers of the managed service provider, includes a cloud-based, monitoring system.

While for sake of brevity, only three data centers are shown in the context of the present example, it is to be appreciated that additional clusters owned by or leased by the same or different companies (data storage subscribers/customers) may be monitored and one or more metrics may be estimated based on data stored within a given level of a data store in accordance with the methodologies described herein and such clusters may reside in multiple data centers of different types (e.g., enterprise data centers, managed services data centers, or colocation data centers).

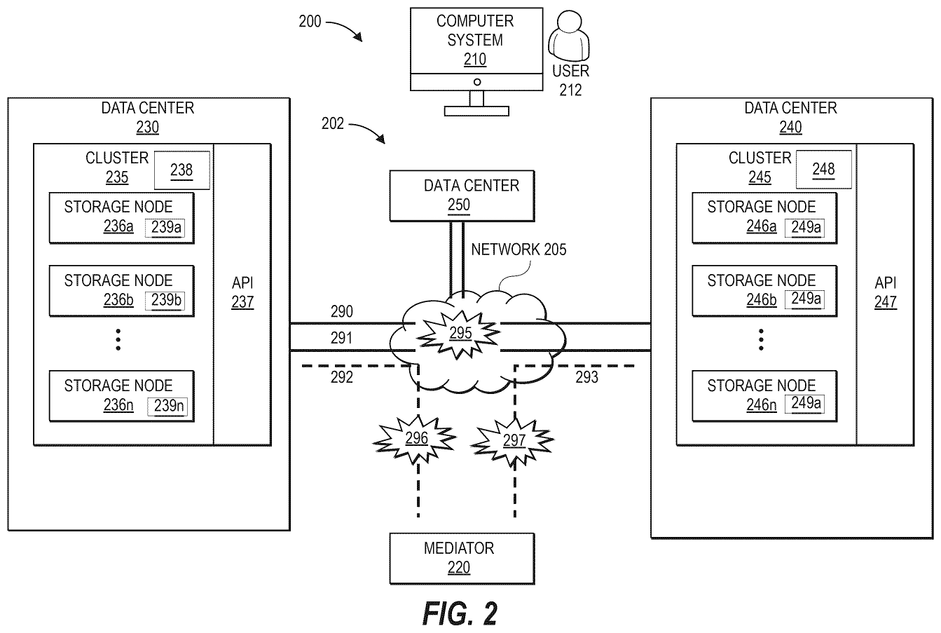

FIG. 2 is a block diagram illustrating an environment 200 having potential failures within a multi-site distributed storage system 202 in which various embodiments may be implemented. In various examples described herein, an administrator (e.g., user 212) of a multi-site distributed storage system 202 having clusters 235 and cluster 245 or a managed service provider responsible for multiple distributed storage systems of the same or multiple customers may monitor various operations and network conditions of the distributed storage system or multiple distributed storage systems via a browser-based interface presented on computer system 210.

In the context of the present example, the system 202 includes data center 230, data center 240, an optional data center 250, and optionally a mediator 220. The data centers 230, 240, and 250, the mediator 220, and the computer system 210 are coupled in communication via a network 205, which, depending upon the particular implementation, may be a Local Area Network (LAN), a Wide Area Network (WAN), or the Internet.

The data centers 230, 240, and 250 may represent an enterprise data center (e.g., an on-premises customer data center) that is owned and operated by a company or the data center 230 may be managed by a third party (or a managed service provider) on behalf of the company, which may lease the equipment and infrastructure. Alternatively, the data centers 230, 240 and 250 may represent a colocation data center in which a company rents space of a facility owned by others and located off the company premises. The data centers 230 and 240 are shown with a cluster (e.g., cluster 235, cluster 245). The data center 250 includes similar components as data centers 230 and 240. Those of ordinary skill in the art will appreciate additional IT infrastructure may be included within the data centers 230 and 240. In one example, the data center 240 is a mirrored copy of the data center 230 to provide non-disruptive operations at all times even in the presence of failures including, but not limited to, network disconnection between the data centers 230 and 240 and the mediator 220, which can also be a data center.

The system 202 can utilize communications 290 and 291 to synchronize a mirrored copy of data of the data center 240 with a primary copy of the data of the data center 230. Either of the communications 290 and 291 between the data centers 230 and 240 may have a failure 295. In a similar manner, a communication 292 between data center 230 and mediator 220 may have a failure 296 while a communication 293 between the data center 240 and the mediator 220 may have a failure 297. If not responded to appropriately, these failures whether transient or permanent have the potential to disrupt operations for users of the distributed storage system 202. In one example, communications between the data centers 230 and 240 have approximately a 5-20 millisecond round trip time.

Turning now to the cluster 235, it includes a configuration database 238, at least two storage nodes 236a-b, optionally includes additional storage nodes (e.g., 236n) and an Application Programming Interface (API) 237. The storage nodes 236a-n each include a respective mediator agent 239a-n. In the context of the present example, the multiple storage nodes are organized as a cluster and provide a distributed storage architecture to service storage requests issued by one or more clients of the cluster. The data served by the storage nodes may be distributed across multiple storage units embodied as persistent storage devices, including but not limited to HDDs, SSDs, flash memory systems, or other storage devices.

Turning now to the cluster 245, it includes a configuration database 248, at least two storage nodes 246a-b, optionally includes additional storage nodes (e.g., 246n) and includes an Application Programming Interface (API) 247. The storage nodes 246a-n each include a respective mediator agent 249a-n. In the context of the present example, the multiple storage nodes are organized as a cluster and provide a distributed storage architecture to service storage requests issued by one or more clients of the cluster. The data served by the storage nodes may be distributed across multiple storage units embodied as persistent storage devices, including but not limited to HDDs, SSDs, flash memory systems, or other storage devices.

A synchronous replication from a primary copy of data at a primary storage site (e.g., cluster 235) to a secondary copy of data at a secondary storage site (e.g., cluster 245) can fail due to inter cluster or cluster to mediator connectivity issues (e.g., failures 295, 296, 297). These issues can occur if the secondary storage site can not differentiate between the primary storage site being non-operational (or isolation), or just a network partition. A trigger for the automated failover is generated from a data path and if the data path is lost, this can lead to disruption. A data replication relationship between the primary and secondary storage sites guarantees non-disruptiveness due to allowing I/O operations to be handled with the secondary mirror copy of data. However, there are timing windows between the primary storage site being non-operational and the secondary mirror copy being ready to serve I/O operations where a second failure can lead to disruption. For example, a controller failure can occur in a cluster hosting the secondary mirror copy of the data. The failover feature of the present design guarantees non-disruptive operations (e.g., operations of business enterprise applications, operations of software application) even in the presence of these multiple failures.

In one example, each cluster can have up to 5 consistency groups with each consistency group having up to 12 volumes. The system 202 provides an automatic unplanned failover feature at a consistency group granularity. The failover feature allows switching storage access from a primary copy of the data center 230 to a mirror copy of the data center 240 or vice versa.

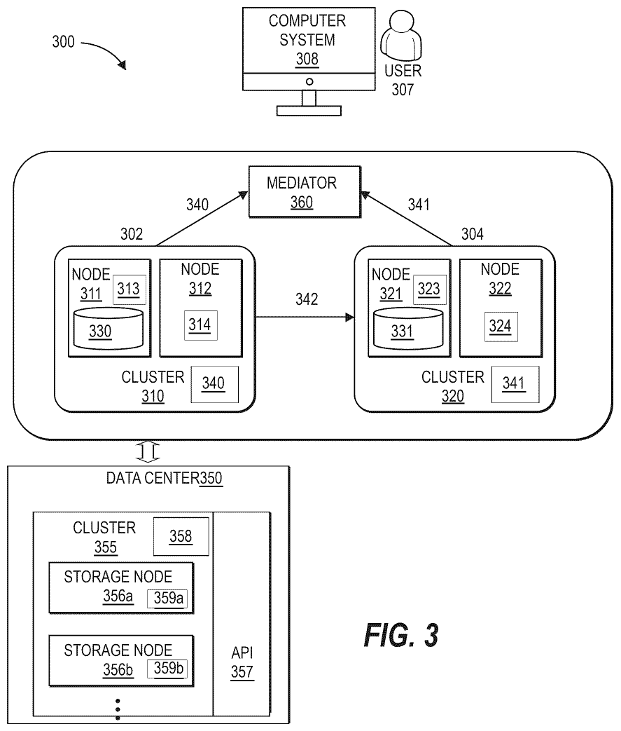

FIG. 3 is a block diagram illustrating a multi-site distributed storage system 300 in which various embodiments may be implemented. In various examples described herein, an administrator (e.g., user 307) of the multi-site distributed storage system 300 or a managed service provider responsible for multiple distributed storage systems of the same or multiple customers may monitor various operations and network conditions of the distributed storage system or multiple distributed storage systems via a browser-based interface presented on computer system 308. In the context of the present example, the distributed storage system 300 includes a data center 302 having a cluster 310, a data center 304 having a cluster 320, an optional data center 350 having a cluster 355, and a mediator 360. The clusters 310, 320, 355, and the mediator 360 are coupled in communication (e.g., communications 340-342) via a network, which, depending upon the particular implementation, may be a Local Area Network (LAN), a Wide Area Network (WAN), or the Internet.

The cluster 310 includes nodes 311 and 312, the cluster 320 includes nodes 321 and 322, and the optional cluster 355 includes nodes 356a and 356b. In one example, the cluster 320 has a data copy 331 that is a mirrored copy of the data copy 330 to provide non-disruptive operations at all times even in the presence of multiple failures including, but not limited to, network disconnection between the data centers 302 and 304 and the mediator 360. The cluster 355 may have an asynchronous replication relationship with cluster 310 or a mirror vault policy. The cluster 355 includes a configuration database 358, multiple storage nodes 356a-b each having a respective mediator agent 359a-b, and an Application Programming Interface (API) 357.

The multi-site distributed storage system 300 provides correctness of data, availability, and redundancy of data. In one example, the node 311 is designated as a leader and the node 321 is designated as a follower. The leader is given preference to serve I/O operations to requesting clients and this allows the leader to obtain a consensus in a case of a race between the clusters 310 and 320. The mediator 360 enables an automated unplanned failover (AUFO) in the event of a failure. The data copy 330 (leader), data copy 331 (follower), and the mediator 360 form a three way quorum. If two of the three entities reach an agreement for whether the leader or follower should serve I/O operations to requesting clients, then this forms a strong consensus.

The leader and follower roles for the clusters 310 and 320 help to avoid a split-brain situation with both of the clusters simultaneously attempting to serve I/O operations. For example, the leader may become unresponsive while a mediator detects this unresponsiveness to be a leader non-operational situation. The leader being non-operational can potentially cause a race between leader and follower copy both simultaneously attempting to obtain a consensus. However, only one of the leader and the follower should win the race and then be allowed to handle I/O operations. If this race is not prevented, it can result in the split-brain situation.

There are scenarios where both leader and follower copies can claim to be a leader copy. In one example, a follower cannot serve I/O until an AUFO happens. A leader doesn't serve I/O operations until the leader obtains a consensus.

The mediator agents (e.g., 313, 314, 323, 324, 359a, 359b) are configured on each node within a cluster. The system 300 can perform appropriate actions based on event processing of the mediator agents. The mediator agent(s) processes events that are generated at a lower level (e.g., volume level, node level) and generates an output for a consistency group level. In one example, the nodes 311, 312, 321, and 322 form a consistency group. The mediator agent provides services for various events (e.g., simultaneous events, conflicting events) generated in a business data replication relationship between each cluster.

The multi-site distributed storage system 300 presents a single virtual logical unit number (LUN) to a host computer or client using a synchronized-replicated distributed copies of a LUN. A LUN is a unique identifier for designating an individual or collection of physical or virtual storage devices that execute input/output (I/O) commands with a host computer, as defined by the Small System Computer Interface (SCSI) standard. In one example, active or passive access to this virtual LUN causes read and write commands to be serviced only by node 311 (leader) while operations received by the node 321 (follower) are proxied to node 311.

### Example Storage Node

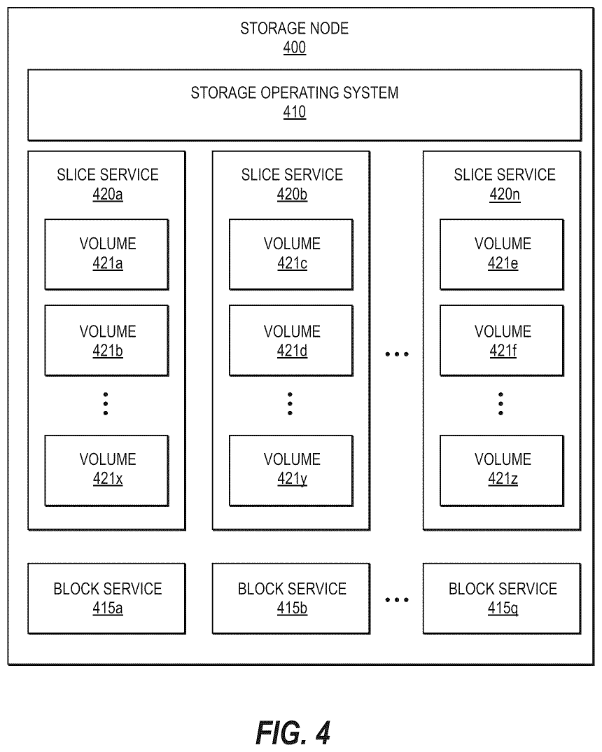

FIG. 4 is a block diagram illustrating a storage node 400 in accordance with an embodiment of the present disclosure. Storage node 400 represents a non-limiting example of storage nodes (e.g., 136a-n, 146a-n, 236a-n, 246a-n, 311, 312, 331, 322, 712, 714, 752, 754) described herein. In the context of the present example, a storage node 400 may be a network storage controller or controller that provides access to data stored on one or more volumes. The storage node 400 includes a storage operating system 410, one or more slice services 420a-n, and one or more block services 415a-q. The storage operating system (OS) 410 may provide access to data stored by the storage node 400 via various protocols (e.g., small computer system interface (SCSI), Internet small computer system interface (ISCSI), fibre channel (FC), common Internet file system (CIFS), network file system (NFS), hypertext transfer protocol (HTTP), web-based distributed authoring and versioning (WebDAV), or a custom protocol. A non-limiting example of the storage OS 410 is NetApp Element Software (e.g., the SolidFire Element OS) based on Linux and designed for SSDs and scale-out architecture with the ability to expand up to 100 storage nodes.

Each slice service 420 may include one or more volumes (e.g., volumes 421a-x, volumes 421c-y, and volumes 421e-z). Client systems (not shown) associated with an enterprise may store data to one or more volumes, retrieve data from one or more volumes, and/or modify data stored on one or more volumes.

The slice services 420a-n and/or the client system may break data into data blocks. Block services 415a-q and slice services 420a-n may maintain mappings between an address of the client system and the eventual physical location of the data block in respective storage media of the storage node 400. In one embodiment, volumes 421 include unique and uniformly random identifiers to facilitate even distribution of a volume's data throughout a cluster (e.g., cluster 135). The slice services 420a-n may store metadata that maps between client systems and block services 415. For example, slice services 420 may map between the client addressing used by the client systems (e.g., file names, object names, block numbers, etc. such as Logical Block Addresses (LBAs)) and block layer addressing (e.g., block IDs) used in block services 415. Further, block services 415 may map between the block layer addressing (e.g., block identifiers) and the physical location of the data block on one or more storage devices. The blocks may be organized within bins maintained by the block services 415 for storage on physical storage devices (e.g., SSDs).

As noted above, a bin may be derived from the block ID for storage of a corresponding data block by extracting a predefined number of bits from the block identifiers. In some embodiments, the bin may be divided into buckets or “sublists” by extending the predefined number of bits extracted from the block identifier. A bin identifier may be used to identify a bin within the system. The bin identifier may also be used to identify a particular block service 415a-q and associated storage device (e.g., SSD). A sublist identifier may identify a sublist with the bin, which may be used to facilitate network transfer (or syncing) of data among block services in the event of a failure or crash of the storage node 400. Accordingly, a client can access data using a client address, which is eventually translated into the corresponding unique identifiers that reference the client's data at the storage node 400.

For each volume 421 hosted by a slice service 420, a list of block IDs may be stored with one block ID for each logical block on the volume. Each volume may be replicated between one or more slice services 420 and/or storage nodes 400, and the slice services for each volume may be synchronized between each of the slice services hosting that volume. Accordingly, failover protection may be provided in case a slice service 420 fails, such that access to each volume may continue during the failure condition.

### Consistency Groups

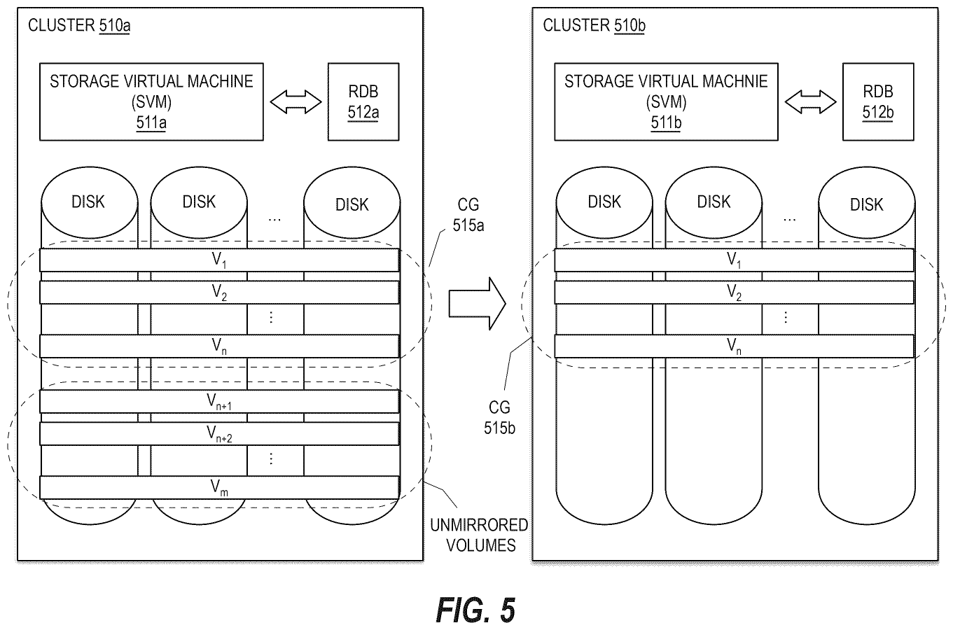

FIG. 5 is a block diagram illustrating the concept of a consistency group (CG) in accordance with an embodiment of the present disclosure. In the context of the present example, a stretch cluster including two clusters (e.g., cluster 510a and 510b) is shown. The clusters may be part of a cross-site high-availability (HA) solution that supports zero recovery point objective (RPO) and zero recovery time objective (RTO) protections by, among other things, providing a mirror copy of a dataset at a remote location, which is typically in a different fault domain than the location at which the dataset is hosted. For example, cluster 510a may be operable within a first site (e.g., a local data center) and cluster 510b may be operable within a second site (e.g., a remote data center) so as to provide non-disruptive operations even if, for example, an entire data center becomes non-functional, by seamlessly failing over the storage access to the mirror copy hosted in the other data center.

According to some embodiments, various operations (e.g., data replication, data migration, data protection, failover, storage expansion, container expansion, conversion process, and the like) may be performed at the level of granularity of a CG (e.g., CG 515a or CG 515b). A CG is a collection of storage objects or data containers (e.g., volumes) within a cluster that are managed by a Storage Virtual Machine (e.g., SVM 511a or SVM 511b) as a single unit. In various embodiments, the use of a CG as a unit of data replication guarantees a dependent write-order consistent view of the dataset and the mirror copy to support zero RPO and zero RTO. CGs may also be configured for use in connection with taking simultaneous snapshot images of multiple volumes, for example, to provide crash-consistent copies of a dataset associated with the volumes at a particular point in time.

The volumes of a CG may span multiple disks (e.g., electromechanical disks and/or SSDs, redundant array of independent (RAID) disks) of one or more storage nodes of the cluster. RAID disks store the same data in different place on multiple hard disks or SSDs to protect data in case of a drive failure. A CG may include a subset or all volumes of one or more storage nodes. In one example, a CG includes a subset of volumes of a first storage node and a subset of volumes of a second storage node. In another example, a CG includes a subset of volumes of a first storage node, a subset of volumes of a second storage node, and a subset of volumes of a third storage node. A CG may be referred to as a local CG or a remote CG depending upon the perspective of a particular cluster. For example, CG 515a may be referred to as a local CG from the perspective of cluster 510a and as a remote CG from the perspective of cluster 510b. Similarly, CG 515a may be referred to as a remote CG from the perspective of cluster 510b and as a local CG from the perspective of cluster 510b. At times, the volumes of a CG may be collectively referred to herein as members of the CG and may be individually referred to as a member of the CG. In one embodiment, members may be added or removed from a CG after it has been created.

A cluster may include one or more SVMs, each of which may contain data volumes and one or more logical interfaces (LIFs) (not shown) through which they serve data to clients. SVMs may be used to securely isolate the shared virtualized data storage of the storage nodes in the cluster, for example, to create isolated partitions within the cluster. In one embodiment, an LIF includes an Internet Protocol (IP) address and its associated characteristics. Each SVM may have a separate administrator authentication domain and can be managed independently via a management LIF to allow, among other things, definition and configuration of the associated CGs.

In the context of the present example, the SVMs make use of a configuration database (e.g., replicated database (RDB) 512a and 512b), which may store configuration information for their respective clusters. A configuration database provides cluster wide storage for storage nodes within a cluster. The configuration information may include relationship information specifying the status, direction of data replication, relationships, and/or roles of individual CGs, a set of CGs, members of the CGs, and/or the mediator. A pair of CGs may be said to be “peered” when one is protecting the other. For example, a CG (e.g., CG 515b) to which data is configured to be synchronously replicated may be referred to as being in the role of a destination CG, whereas the CG (e.g., CG 515a) being protected by the destination CG may be referred to as the source CG. Various events (e.g., transient or persistent network connectivity issues, availability/unavailability of the mediator, site failure, and the like) impacting the stretch cluster may result in the relationship information being updated at the cluster and/or the CG level to reflect changed status, relationships, and/or roles.

The level of granularity of operations supported by a CG is useful for various types of applications. As a non-limiting example, consider an application, such as a database application, that makes use of multiple volumes, including maintaining logs on one volume and the database on another volume. In such a case, the application may be assigned to a local CG of a first cluster that maintains the primary dataset, including an appropriate number of member volumes to meet the needs of the application, and a remote CG, for maintaining a mirror copy of the primary dataset, may be established on a second cluster to protect the local CG.

While in the context of various embodiments described herein, a volume of a CG may be described as performing certain actions (e.g., taking other members of a CG out of synchronization, disallowing/allowing access to the dataset or the mirror copy, issuing consensus protocol requests, etc.), it is to be understood such references are shorthand for an SVM or other controlling entity, managing or containing the volume at issue, performing such actions on behalf of the volume.

While in the context of various examples described herein, data replication may be described as being performed in a synchronous manner between a paired set of (or “peered”) CGs associated with different clusters (e.g., from a primary cluster to a secondary cluster), data replication may also be performed asynchronously and/or within the same cluster. Similarly, a single remote CG may protect multiple local CGs and/or multiple remote CGs may protect a single local CG. For example, a local CG can be setup for double protection by two remote CGs via fan-out or cascade topologies. In addition, those skilled in the art will appreciate a cross-site high-availability (HA) solution may include more than two clusters, in which a mirrored copy of a dataset of a primary cluster is stored on more than one secondary cluster.

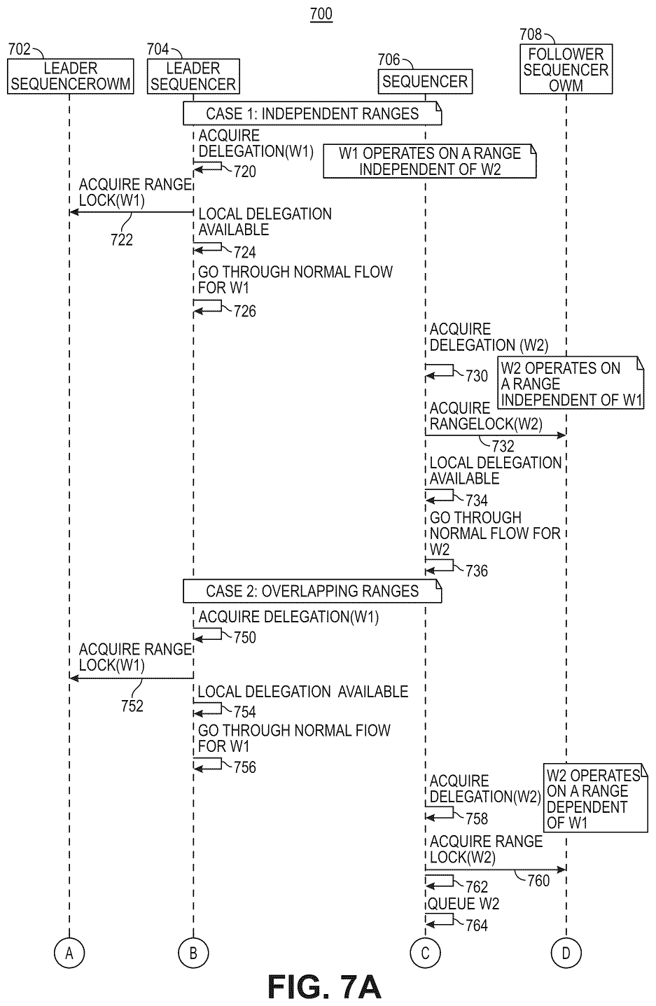

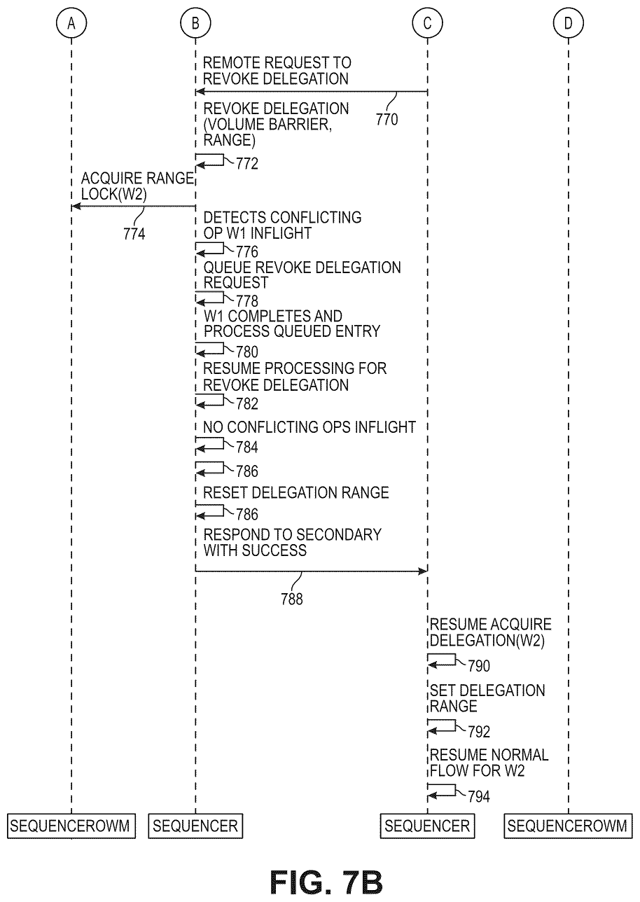

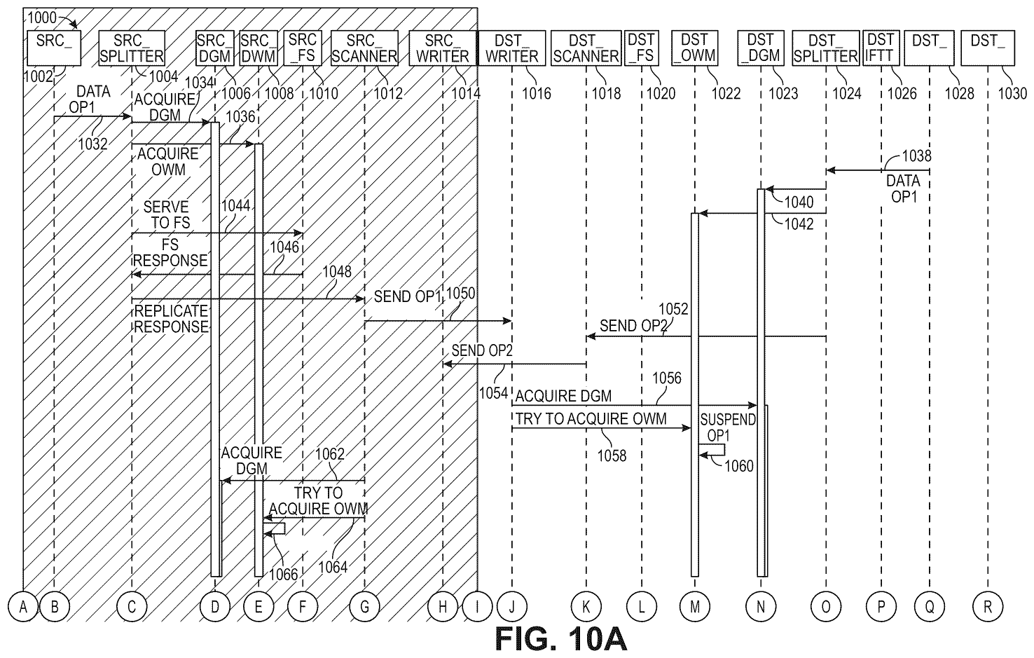

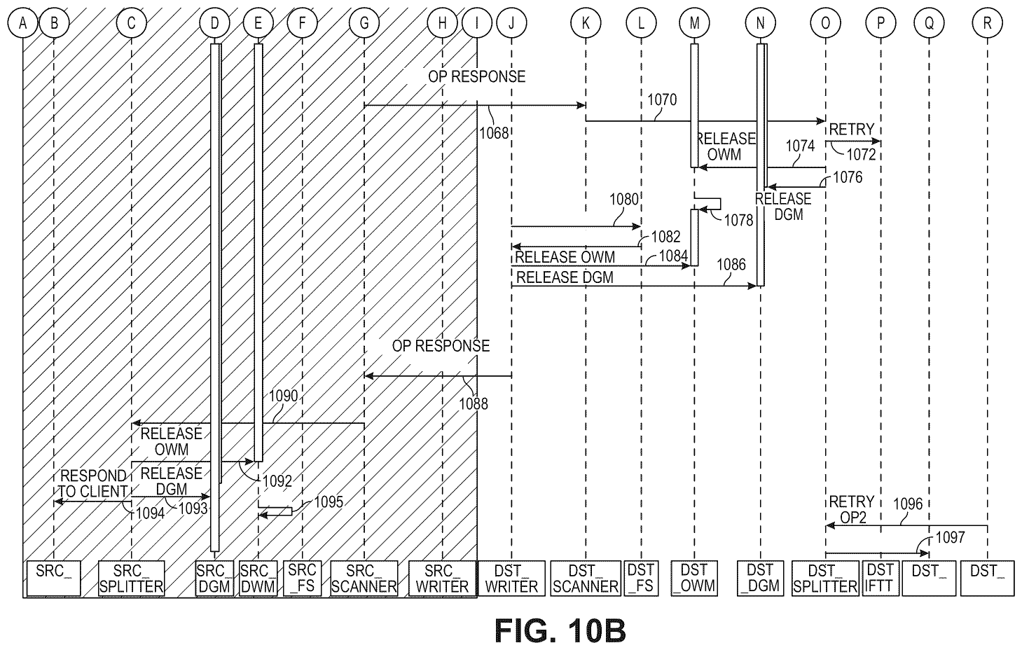

The various nodes (e.g., storage nodes) of the distributed storage systems described herein, and the processing described below with reference to the flow diagrams of FIGS. 7A-12B may be implemented in the form of executable instructions stored on a machine readable medium and executed by a processing resource (e.g., a microcontroller, a microprocessor, central processing unit core(s), an application-specific integrated circuit (ASIC), a field programmable gate array (FPGA), and the like) and/or in the form of other types of electronic circuitry. For example, the processing may be performed by one or more virtual or physical computer systems (e.g., servers, network storage systems or appliances, blades, etc.) of various forms, such as the computer systems described with reference to FIGS. 10-12 below.

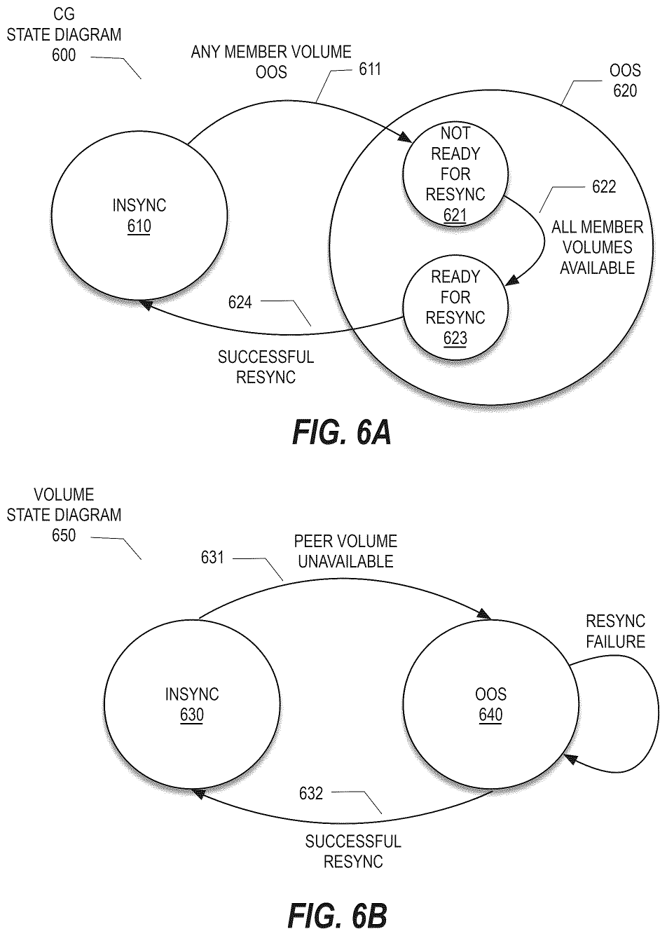

FIG. 6A is a CG state diagram 600 in accordance with an embodiment of the present disclosure. In the context of the present example, the data replication status of a CG can generally be in either of an InSync state (e.g., InSync 610) or an OOS state (e.g., OOS 620). Within the OOS state, two sub-states are shown, a not ready for resync state 621 and a ready for resync state 623.

While a given CG is in the InSync state, the mirror copy of the primary dataset associated with the member volumes of the given CG may be said to be in-synchronization with the primary dataset and asynchronous data replication or synchronous data replication, as the case may be, are operating as expected. When a given CG is in the OOS state, the mirror copy of the primary dataset associated with the member volumes of the given CG may be said to be out-of-synchronization with the primary dataset and asynchronous data replication or synchronous data replication, as the case may be, are unable to operate as expected. Information regarding the current state of the data replication status of a CG may be maintained in a configuration database (e.g., RDB 512a or 512b).

As noted above, in various embodiments described herein, the members (e.g., volumes) of a CG may be managed as a single unit for various situations. In the context of the present example, the data replication status of a given CG is dependent upon the data replication status of the individual member volumes of the CG. A given CG may transition 611 from the InSync state to the not ready for resync state 621 of the OOS state responsive to any member volume of the CG becoming OOS with respect to a peer volume with which the member volume is peered. A given CG may transition 622 from the not ready for resync state 621 to the ready for resync state 623 responsive to all member volumes being available. In order to support recovery from, among other potential disruptive events, manual planned disruptive events (e.g., balancing of CG members across a cluster) a resynchronization process is provided to bring the CG back into the InSync state from the OOS state. Responsive to a successful CG resync, a given CG may transition 624 from the ready for resync state 623 to the InSync state.

Although outside the scope of the present disclosure, for completeness it is noted that additional state transitions may exist. For example, in some embodiments, a given CG may transition from the ready for resync state 623 to the not ready for resync state 621 responsive to unavailability of a mediator (e.g., mediator 120) configured for the given CG. In such an embodiment, the transition 622 from the not ready for resync state 621 to the ready for resync state 623 should additionally be based on the communication status of the mediator being available.

FIG. 6B is a volume state diagram 650 in accordance with an embodiment of the present disclosure. In the context of the present example, the data replication status of a volume can be in either of an InSync state (e.g., InSync 630) or an OOS state (e.g., OOS 640). While a given volume of a local CG (e.g., CG 515a) is in the InSync state, the given volume may be said to be in-synchronization with a peer volume of a remote CG (e.g., CG 515b) and the given volume and the peer volume are able to communicate with each other via the potentially unreliable network (e.g., network 205), for example, through their respective LIFs. When a given volume of the local CG is in the OOS state, the given volume may be said to be out-of-synchronization with the peer volume of the remote CG and the given volume and the peer volume are unable to communicate with each other. According to one embodiment, a periodic health check task may continuously monitor the ability to communicate between a pair of peered volumes. Information regarding the current state of the data replication status of a volume may be maintained in a configuration database (e.g., RDB 512a or 512b).

A given volume may transition 631 from the InSync state to the OOS state responsive to a peer volume being unavailable. A given volume may transition 632 from the OOS state to the InSync state responsive to a successful resynchronization with the peer volume. As described below in further detail, in one embodiment, two different types of resynchronization approaches may be implemented, including a Fast Resync process and a CG-level resync process, and selected for use individually or in sequence as appropriate for the circumstances.

### Conflict Resolution Techniques for an Active/Active Bidirectional Synchronous Replication Storage System

The present storage solution provides different techniques for handling dependent operations, conflicting operations, and metadata operations on primary and secondary storage sites. In one example, a delegation technique handles dependent operations in a bidirectional Active/Active storage system. In this approach, a server (e.g., a leader, primary storage site) delegates the management of specific regions of a file to a client (e.g., a follower, secondary storage site). This delegation allows the follower to have exclusive access, eliminating the need to explicitly coordinate with the leader on a per operation (op) basis. This leader-issued delegation-protocol based design allows both copies of data to establish a negotiated understanding of non-overlapping regions in a stretched storage object.

FIGS. 7A and 7B illustrate a flow diagram for a computer-implemented method for a delegation technique (e.g., delegation process) to handle dependent operations for a symmetric distributed storage system having Active/Active bi-directional synchronous replication with concurrent read/write access to both copies of data on primary and secondary storage sites in accordance with an embodiment of the present disclosure. State information regarding members (e.g., storage volumes) of a local CG can be maintained. The state information may include a data replication status of a mirror copy of a dataset associated with a local CG (e.g., CG 515a) may be maintained, for example, to facilitate automatic triggering of resynchronization. For example, the state information may include information relating to the current availability or unavailability of a peer volume of a remote CG corresponding to a member volume of the local CG and/or the data replication state of the local CG. In one embodiment, the state information may track the current state of a given CG and a given volume consistent with the state diagrams of FIG. 6A and FIG. 6B.

Although the operations in the computer-implemented method 700 are shown in a particular order, the order of the actions can be modified. Thus, the illustrated embodiments can be performed in a different order, and some operations may be performed in parallel. Some of the operations listed in FIGS. 7A and 7B are optional in accordance with certain embodiments. The numbering of the operations presented is for the sake of clarity and is not intended to prescribe an order of operations in which the various operations must occur. Additionally, operations from the various flows may be utilized in a variety of combinations.

The operations of computer-implemented method 700 may be executed by a storage controller, a storage virtual machine (e.g., SVM 511a, SVM 511b), a mediator (e.g., mediator 120, mediator 220, mediator 360), a mediator agent (e.g., mediator agent 139a-139n, mediator agent 149a-149n, mediator agent 239a-239n, mediator agent 249a-249n, mediator agent 313, 314, 323, 324, mediator agent 439), a multi-site distributed storage system, a computer system, a machine, a server, a web appliance, a centralized system, a distributed node, or any system, which includes processing logic (e.g., one or more processors, a processing resource). The processing logic may include hardware (circuitry, dedicated logic, etc.), software (such as is run on a general purpose computer system or a dedicated machine or a device), or a combination of both.

The computer-implemented method includes establishing bi-directional synchronous replication between one or more members of a first consistency group (CG1) of the primary storage site (e.g., leader site) and one or more members of a second consistency group (CG2) of the secondary storage site (e.g., follower site) with each storage node having read/write access while maintaining zero recovery point objective (RPO) and Zero recovery time objective (RTO).

In one embodiment, a multi-site distributed storage system includes a primary storage site having a first cluster with a primary copy of data in a consistency group (CG1). The consistency group of the first cluster is initially assigned a primary role. A second cluster of the secondary storage site has a secondary mirror copy of the data in a consistency group. The consistency group of the second cluster (CG2) is initially assigned a secondary role. The storage system handles input/output (I/O) requests from the client device having an application. The primary storage site and secondary storage site communicate via a network.

A sequencer at the primary storage site (e.g., leader site) grants and revokes delegation to any range, while a sequencer at the secondary storage site (e.g., follower site) requests delegation. A sequencer can be hardware and/or software to read data and process data for a sequence of operations. The primary and secondary site sequencers cache their granted delegations and can freely use it to process operations locally until it is revoked by the primary storage site.

The primary site revokes a delegation when it receives a local request that is found to be dependent on an existing granted delegation to the secondary site. Delegations expire automatically once the replication relationship between CG1 and CG2 is Out-of-Sync (OOS). Delegations are in-core structures and get cleaned up as a synchronous replication splitter acts as a pass-through when not InSync. This present design is efficient and works well for active/active workloads where the overlapping writes are a very small percentage of the total operations. It provides a symmetric performance profile for data operations with the benefits of parallel splitting. There is a 2× round-trip time (RTT) constant penalty until the cache is warmed up. However, this technique is not suitable for a single host server deployment that uses multi-pathing to round-robin to both copies of a bidirectional replication stretched storage/logical unit number (LUN), as this results in many conflicts and therefore a lot of conflict resolution overhead in the steady state data path.

For a first example in which first and second write Ops operate on independent ranges, at operation 720, a leader sequencer 704 (or primary sequencer) of the primary storage site, which is assigned a leader role for serving I/O) initializes acquiring delegation for a first write Op (w1). At operation 722, an overlap write manager (OWM) 702 acquires a byte range lock for the first write Op. At operation 724, the sequencer 704 determines that local delegation on the primary storage site is available for the first write Op (e.g., no conflicting Op operating on same range as first write Op). At operation 726, the sequencer proceeds with a normal workflow for writing the first write Op on the primary storage site.

At operation 730, a follower sequencer 706 (or secondary sequencer) of the secondary storage site, which is assigned a follower role for serving I/O, initializes acquiring delegation for a second write Op (w2). At operation 732, an overlap write manager (OWM) 708 acquires a byte range lock for the second write Op. At operation 734, the sequencer 706 determines that local delegation on the secondary storage site is available for the second write Op (e.g., no conflicting Op operating on same range as second write Op). At operation 736, the sequencer proceeds with a normal workflow for writing the second write Op on the secondary storage site.

For a second example in which first and second write Ops operate on overlapping ranges, at operation 750, a sequencer 704 of the primary storage site (e.g., primary sequencer) initializes acquiring delegation for a first write Op (w1). At operation 752, an overlap write manager (OWM) 702 acquires a byte range lock for the first write Op. At operation 754, the sequencer 704 determines that local delegation on the primary storage site is available for the first write Op (e.g., no conflicting Op operating on same range as first write Op). At operation 756, the sequencer proceeds with a normal workflow for writing the first write Op on the primary storage site.

At operation 758, a sequencer 706 of the secondary storage site (e.g., secondary sequencer) initializes acquiring delegation for a second write Op (w2). At operation 760, the overlap write manager (OWM) 708 acquires a byte range lock for the second write Op. At operation 762, the sequencer 706 determines that local delegation on the secondary storage site is not available for the second write Op (e.g., determines conflicting first write Op operating on same range as second write Op). At operation 764, the sequencer 706 queues the second write Op on the secondary storage site. At operation 770, the sequencer 706 sends a remote request to the sequencer 704 to revoke delegation (e.g., volume barrier, range) for the second write Op. At operation 772, the sequencer 704 revokes delegation (e.g., volume barrier, range) for the second write Op. At operation 774, the sequencer 704 sends a message to the OWM 702 to acquire a range lock for the second write Op. At operation 776, the sequencer 704 detects that the inflight first write Op has a range that conflicts with a range of the second write Op. At operation 778, the sequencer 704 queues the revoke delegation request for the second write Op. At operation 780, the sequencer 704 completes writing of the first write Op and processes a queued entry for the revoke delegation request. At operation 782, the sequencer 704 resumes processing for the revoke delegation request for the second write Op. At operation 784, the sequencer 704 determines no conflicting inflight Ops for the second write Op. At operation 786, the sequencer 704 resets a delegation range for the second write Op. At operation 788, the sequencer 704 sends a delegation success message to the sequencer 706 of the secondary storage site for the second write Op. At operation 790, the sequencer 706 resumes acquiring delegation for the second write Op. At operation 792, the sequencer 706 sets a delegation range for the second write Op. At operation 794, the sequencer 706 resumes a normal work flow for writing the second write Op.

In one example, the following Algorithm provides delegation. An AVL tree is a self-balancing binary search tree.

```
// Low level OWM construct
OWM::acquireRangeLock {
  // Search the AVL tree to see if there are any overlapping ops inflight
  if (yes) {
    // Queue the request
    return false;
  } else {
    // Insert an entry into an AVL tree indicating that the range is in use
    return true;
  }
}
OWM::releaseRangeLock( ) {
  // Remove the entry from the AVL tree
  for each (conflicting queued op) {
    // Check if the conflict is still present
    if (no) {
      // Insert an entry into an AVL tree indicating that the range is in
      use
      // Resume processing for this op
    }
  }
}
// Delegation algorithm
Sequencer::AcquireDelegation(op) {
  if (Op is a Volume barrier) {
    // Check if the current sequencer has vol barrier delegation
    if (true) {
      // return
    } else {
      // Queue the incoming op / fail the op (fine for LUN metadata op)
      // Remote request to revoke vol barrier delegation
      // wait for remote response
      // set the delegation
      return
    }
  }
  // Ops is a data op; need range delegation
  // Take Sequencer OWM to safely check and update delegation
  SequencerOWM−>acquireRangeLock(op)
  // Check if the current sequencer has delegation for this range
  if (available) {
    // The current sequencer has the range
  } else {
    // Peer has the range
    // Queue the incoming op
    // Send Remote request to invoke RevokeDelegation
    // wait for remote response
    // set the range delegation
  }
  SequencerOWM−>releaseRangeLock(op)
}
Sequencer::RevokeDelegation(type, range) {
  if (Volume barrier) {
    // Check if the current sequencer has vol barrier delegation
    if (false) {
      // uninitialized case
      // return success
    }
    // check if there are inflight vol barrier ops
    if (no) {
      // revoke case
      // reset the vol barrier delegation
      // return success
    }
    // delegation in use
    // Queue the incoming op and return. It will be woken up as part of
    inflight op completion
  }
  // Range delegation
  // Take Sequencer OWM to safely check and update delegation
  SequencerOWM−>acquireRangeLock(op)
  // Check if the current sequencer has delegation for this range
  if (false) {
    // uninitialized case
    // nothing to be done
  } else {
    // check if there are inflight conflicting ops
    if (no) {
      // revoke case
      // reset the range delegation
    } else {
      // delegation in use
      // Queue the incoming op. It will be woken up as part of inflight op
      completion
    }
  }
  SequencerOWM−>releaseRangeLock(op)
}
```

In the first example with independent ranges, the sequencer of the primary storage site receives the first write Op (e.g., a write operation w1) and acquires a range lock for it. The sequencer of the secondary storage site receives the second write Op (e.g., a write operation w2) that operates on a range independent of w1, and it also acquires a range lock for it. Both operations can proceed without any issues.

In the second case with overlapping ranges, the sequencer of the primary storage site receives a write operation w1 and acquires a range lock for it. However, when the sequencer of the secondary storage site receives a write operation w2 that operates on a range overlapping with w1, sequencer cannot acquire a range lock for w2 and has to queue the write operation w2 and request a range lock from the primary storage site. The primary storage site then releases the range lock for w1 and responds to the secondary storage site with success, allowing the secondary storage site to proceed with writing w2.

### Primary First Sequential Split for an Active/Active Bidirectional Synchronous Replication Storage System

In this dual-copy storage system of the present design, operations are performed in a sequential manner and on a primary copy of data first. In case of conflicts, the requests landing on a primary copy of data on a primary storage site are prioritized over those received by a secondary copy of data on a secondary storage site.

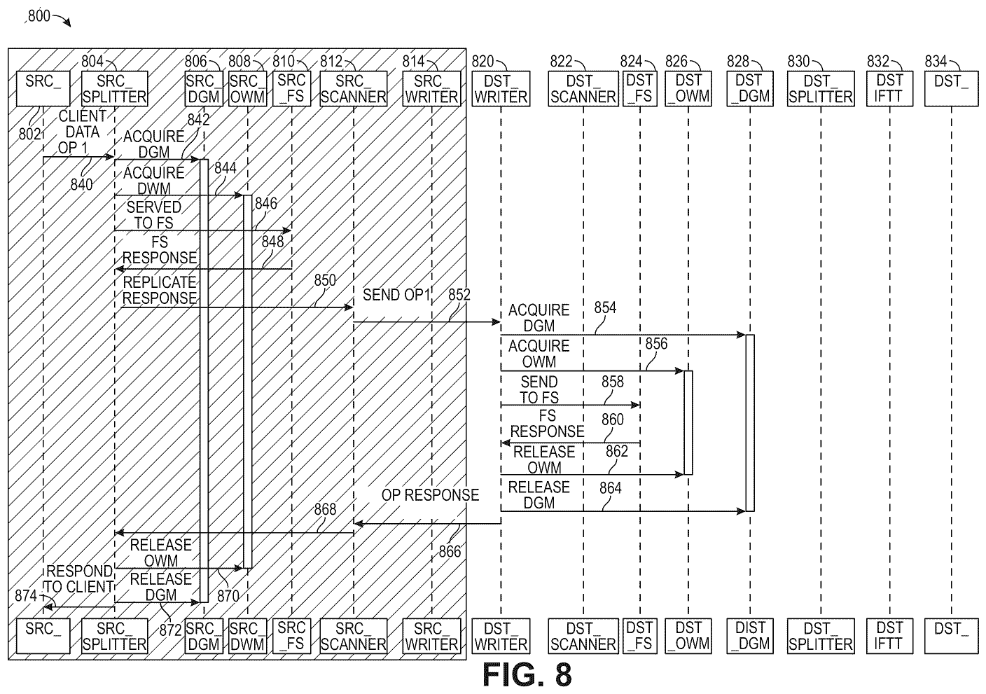

FIG. 8 illustrates a flow diagram for a computer-implemented method of primary first sequential split operations for a symmetric distributed storage system having Active/Active bi-directional synchronous replication in accordance with an embodiment of the present disclosure. State information regarding members (e.g., storage volumes) of a local CG can be maintained. The state information may include a data replication status of a mirror copy of a dataset associated with a local CG (e.g., CG 515a) may be maintained, for example, to facilitate automatic triggering of resynchronization. For example, the state information may include information relating to the current availability or unavailability of a peer volume of a remote CG corresponding to a member volume of the local CG and/or the data replication state of the local CG. In one embodiment, the state information may track the current state of a given CG and a given volume consistent with the state diagrams of FIG. 6A and FIG. 6B.

Although the operations in the computer-implemented method 800 are shown in a particular order, the order of the actions can be modified. Thus, the illustrated embodiments can be performed in a different order, and some operations may be performed in parallel. Some of the operations listed in FIG. 8 are optional in accordance with certain embodiments. The numbering of the operations presented is for the sake of clarity and is not intended to prescribe an order of operations in which the various operations must occur. Additionally, operations from the various flows may be utilized in a variety of combinations.

The operations of computer-implemented method 800 may be executed by a storage controller, a storage virtual machine (e.g., SVM 511a, SVM 511b), a mediator (e.g., mediator 120, mediator 220, mediator 360), a mediator agent (e.g., mediator agent 139a-139n, mediator agent 149a-149n, mediator agent 239a-239n, mediator agent 249a-249n, mediator agent 313, 314, 323, 324, mediator agent 439), a multi-site distributed storage system, a computer system, a machine, a server, a web appliance, a centralized system, a distributed node, or any system, which includes processing logic (e.g., one or more processors, a processing resource). The processing logic may include hardware (circuitry, dedicated logic, etc.), software (such as is run on a general purpose computer system or a dedicated machine or a device), or a combination of both.

Initially, the computer-implemented method includes establishing bi-directional synchronous replication between one or more members of a first storage node of the primary storage site and one or more members of a second storage node of the secondary storage site with each storage node having read/write access while maintaining zero recovery point objective (RPO) and Zero recovery time objective (RTO).

In one embodiment, a multi-site distributed storage system includes a primary storage site (e.g., site A) having a first cluster with a primary copy of data in a consistency group (CG1). The consistency group of the first cluster is initially assigned a primary role. A second cluster of the secondary storage site (e.g., site B) has a secondary mirror copy of the data in a consistency group. The consistency group of the second cluster (CG2) is initially assigned a secondary role. The storage system handles input/output (I/O) requests from the client device having an application.

The primary storage site includes a module 802 to receive operations and requests from a client, a synchronous replication splitter 804, a dependent graph manager (DGM) 806, an overlap write manager 808, a file system 810, a scanner 812, and a writer 814. In a similar manner, the secondary storage site includes a module 834 to receive operations from a client, an inflight tracking module 832, a synchronous replication splitter 830, a dependent graph manager (DGM) 828, an overlap write manager 826, a file system 824, a scanner 822, and a writer 820. In one example, the module 802 parses input (e.g., operations, messages, requests) and turns the input into programmatically meaningful requests encoded in a unified file access protocol.

Data operations for the method 800 are replicated according to the primary-first principle. For example, at operation 840, a data Op 1 received by the primary storage site is executed on primary storage site and then replicated to the secondary storage site. In contrast, a data Op 2 received by secondary storage site is first replicated to primary storage site first and then executed locally.

At operation 842, the synchronous replication splitter 804 sends a message to DGM 806 to perform a dependent graph check (e.g., serialize meta and data Ops). At operation 844, the synchronous replication splitter 804 sends a message to OWM 808 to perform an overlapping write check (e.g., resolve conflict if data Ops writing to a same range). At operation 846, the synchronous replication splitter 804 sends the data Op 1 to the file system 810 to modify the file system based on executing the data Op 1 on the file system of the primary storage site. At operation 848, the file system 810 sends a response from executing the data Op 1 to the synchronous replication splitter 804. At operation 850, the synchronous replication splitter 804 replicates the data Op 1 to the scanner 812, which sends the data Op 1 at operation 852 to a writer 820 of the secondary storage site.

At operation 854, the writer sends a message to DGM 828 to perform a dependent graph check (e.g., serialize meta and data Ops) for acquiring DGM. At operation 856, the writer sends a message to OWM 826 to perform an overlapping write check (e.g., resolve conflict if data Ops writing to a same range) for acquiring OWM. At operation 858, the writer sends the data Op 1 to the file system 824 to modify the file system based on executing the data Op 1 on the file system of the secondary storage site. At operation 860, the file system 824 sends a response from executing the data Op 1 to the writer 820. At operation 862, the writer 820 sends a message to the OWM 826 to release OWM for the data Op 1. At operation 864, the writer 820 sends a message to the DGM 828 to release DGM for the data Op 1.

At operation 866, the writer 820 sends a response from executing the data Op 1 to the scanner 812. At operation 868, the scanner sends the response to the splitter 804. At operation 870, the splitter sends a message to OWM 808 to release OWM for the data Op 1. At operation 872, the splitter sends a message to the DGM 806 to release DGM for the data Op 1. At operation 874, the splitter sends a message to the module 802 for responding to the client to acknowledge completion of data Op 1.

Ops are OWM (Overlapping Write Manager) serialized on both endpoints of the primary and secondary storage sites to ensure ordering of overlapping writes. OWM acquires a byte range lock for each incoming op and suspends an op in case a part of a byte range for the op is already locked by one or more in-progress ops. Upon the completion of the in-progress ops, the suspended op is woken up where it will be able to successfully acquire the byte range lock and proceed.

Metadata operations are allowed on both sides, with secondary-side operations being proxied to the primary and treated further as primary-side ops.

Metadata operations are serialized with other data and metadata ops using DGM (Dependency Graph Manager) on both sides. DGM maintains Inode level counters for inflight data and metadata ops. Scenarios like an incoming meta data op arriving when a data op or another meta data op is in progress or vice versa are treated as conflicts and the incoming op is suspended. Upon the completion of the in-progress ops, the suspended op is woken up where it will be able to successfully acquire the DGM locks and proceed.

Primary side ops suspend upon finding a conflict and resume once the conflicting operation completes. To prevent deadlocks, secondary-side initiated operations back off upon finding a conflict on the primary side and come back to secondary storage site to release the secondary-side locks, making way for the suspended primary-side ops to resume. The secondary-side ops are retried asynchronously afterwards.

A distributed OWM ensures that overlapping writes are executed in the same order on primary and secondary storage sites. Data operations are replicated according to the Primary-First principle. For example, a write request W1 received by the primary storage site is executed on primary storage site and then replicated to secondary, whereas a write request W2 received by secondary is first replicated to primary storage site first and then executed locally. The ops are OWM (Overlapping Write Manager) serialized on both endpoints to ensure ordering of overlapping writes. OWM acquires a byte range lock for each incoming op and suspends it in case a part of byte range is already locked by one or more in-progress ops. Upon completion of the in-progress ops, the suspended op is woken up where it can acquire the byte range lock and proceed.

The order of operations for the ops arriving on the primary storage site will look like as shown in FIG. 8. The op (here after referred to as W1) will first try to acquire OWM locally and it will succeed in doing so, if there are no conflicting ops that are already inflight working on an overlapping byte range. W1 is then sent to the file system 810 to modify the file system as per primary-first principle. At this point any new ops from the primary storage site that have overlapping byte range will get suspended in an OWM queue until the inflight op has released OWM. Upon receiving a successful response from the file system, W1 will now be replicated to the secondary storage site. W1 on second storage site will now try to acquire OWM and it will succeed in doing so, if there are no conflicting ops that are already inflight from secondary. W1 is then sent to the file system 824 to modify the file system. Any new ops from the secondary storage site with an overlapping range will be suspended in OWM queue on the secondary storage site. Upon receiving a successful response from the file system, W1 is good to release OWM on the secondary storage site. The response of replicated op to the primary storage site will release OWM on the primary storage site. At this point W1 is executed on both storage sites and a response can now be sent to client for W1. W1 response to client will asynchronously wake up other ops that have been suspended in OWM queue on the primary storage site, if any, and proceed with its execution.

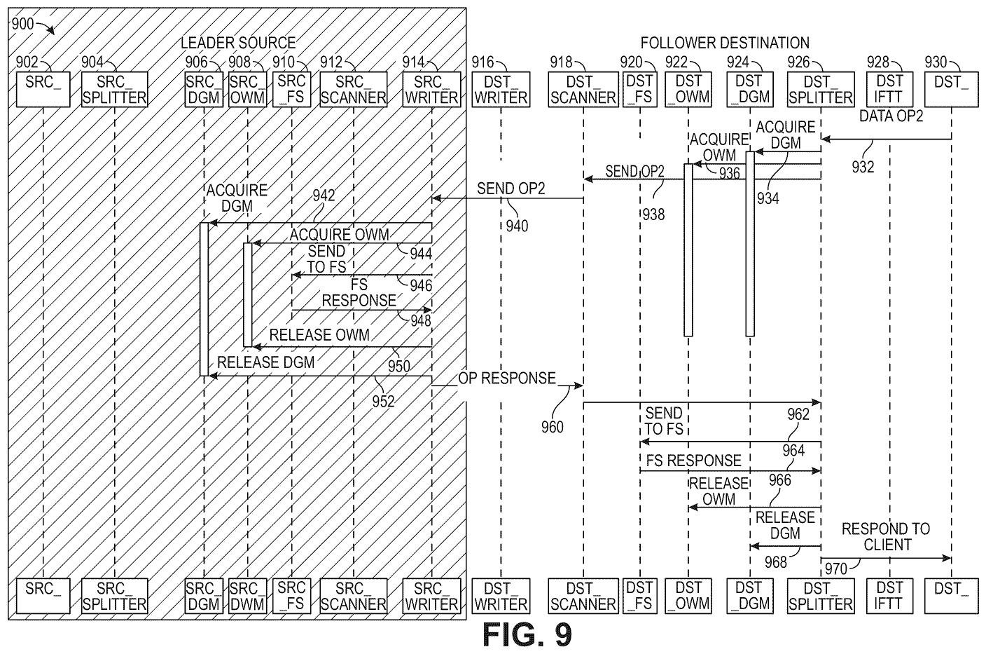

FIG. 9 illustrates a flow diagram for a computer-implemented method of primary first sequential split operations for a data op received on secondary storage site for a symmetric distributed storage system having Active/Active bi-directional synchronous replication in accordance with an embodiment of the present disclosure. State information regarding members (e.g., storage volumes) of a local CG can be maintained. The state information may include a data replication status of a mirror copy of a dataset associated with a local CG (e.g., CG 515a) may be maintained, for example, to facilitate automatic triggering of resynchronization. For example, the state information may include information relating to the current availability or unavailability of a peer volume of a remote CG corresponding to a member volume of the local CG and/or the data replication state of the local CG. In one embodiment, the state information may track the current state of a given CG and a given volume consistent with the state diagrams of FIG. 6A and FIG. 6B.

Although the operations in the computer-implemented method 900 are shown in a particular order, the order of the actions can be modified. Thus, the illustrated embodiments can be performed in a different order, and some operations may be performed in parallel. Some of the operations listed in FIG. 9 are optional in accordance with certain embodiments. The numbering of the operations presented is for the sake of clarity and is not intended to prescribe an order of operations in which the various operations must occur. Additionally, operations from the various flows may be utilized in a variety of combinations.

The operations of computer-implemented method 900 may be executed by a storage controller, a storage virtual machine (e.g., SVM 511a, SVM 511b), a mediator (e.g., mediator 120, mediator 220, mediator 360), a mediator agent (e.g., mediator agent 139a-139n, mediator agent 149a-149n, mediator agent 239a-239n, mediator agent 249a-249n, mediator agent 313, 314, 323, 324, mediator agent 439), a multi-site distributed storage system, a computer system, a machine, a server, a web appliance, a centralized system, a distributed node, or any system, which includes processing logic (e.g., one or more processors, a processing resource). The processing logic may include hardware (circuitry, dedicated logic, etc.), software (such as is run on a general purpose computer system or a dedicated machine or a device), or a combination of both.

Initially, the computer-implemented method includes establishing bi-directional synchronous replication between one or more members of a first storage node of the primary storage site and one or more members of a second storage node of the secondary storage site with each storage node having read/write access while maintaining zero recovery point objective (RPO) and Zero recovery time objective (RTO).

In one embodiment, a multi-site distributed storage system includes a primary storage site (e.g., site A) having a first cluster with a primary copy of data in a consistency group (CG1). The consistency group of the first cluster is initially assigned a primary role. A second cluster of the secondary storage site (e.g., site B) has a secondary mirror copy of the data in a consistency group. The consistency group of the second cluster (CG2) is initially assigned a secondary role. The storage system handles input/output (I/O) requests from the client device having an application.

The primary storage site includes a module 902 to receive operations from a client, a synchronous replication splitter 904, a dependent graph manager (DGM) 906, an overlap write manager 908, a file system 910, a scanner 912, and a writer 914. In a similar manner, the secondary storage site includes a module 930 to receive operations from a client, an inflight tracking module 928, a synchronous replication splitter 926, a dependent graph manager (DGM) 924, an overlap write manager 922, a file system 920, a scanner 918, and a writer 916. The primary storage site can have a leader role and the secondary storage site can have a follower role.

Data operations for the method 900 are replicated according to the Primary-First principle. For example, at operation 932, a data op 2 received by the secondary storage site is sent to a synchronous replication splitter 926.

At operation 934, the synchronous replication splitter 926 sends a message to DGM 924 to perform a dependent graph check (e.g., serialize meta and data Ops). At operation 936, the synchronous replication splitter sends a message to OWM 922 to perform an overlapping write check (e.g., resolve conflict if any data Ops writing to a same range) and it will succeed in obtaining OWM locally if no conflicting ops are already inflight working on an overlapping byte range.

At operation 938, the synchronous replication splitter sends the data Op 2 to the scanner 918, which forwards the data Op 2 to a writer 914 of the primary storage site at operation 940. At operation 942, the writer sends a message to DGM 906 to perform a dependent graph check for acquiring DGM. At operation 944, the writer sends a message to OWM 908 to perform an overlapping write check (e.g., resolve conflict if any data Ops writing to a same range) for acquiring OWM. At operation 946, the writer sends the data Op 2 to the file system 910 to modify the file system based on executing the data Op 2 on the file system of the primary storage site. At operation 948, the file system sends a response from executing the data Op 2 to the writer 914. At operation 950, the writer 914 sends a message to the OWM 908 to release OWM for the data Op 2. At operation 952, the writer sends a message to the DGM 906 to release DGM for the data Op 2.

At operation 960, the writer 914 sends a response from executing the data Op 2 to the scanner 918 of the secondary storage site having a follower role. At operation 962, the scanner sends the response to the splitter 926. At operation 964, the file system 920 sends a response to the splitter 926, which sends a message to OWM 922 to release OWM for the data Op 2 at operation 966. At operation 968, the splitter sends a message to the DGM to release DGM for the data Op 2. At operation 970, the splitter sends a message to the module 930 for responding to the client to acknowledge completion of data Op 2.

For the method 900, the data op 2 received on the secondary storage site will first try to acquire OWM locally and it will succeed in doing so, if there are no conflicting ops that are already inflight working on an overlapping byte range. The data op 2 is then sent to the primary storage site as per primary-first principle, where it will try to acquire OWM and it will succeed in doing so, if there are no conflicting ops that are already inflight from the primary storage site. The data op 2 is then sent to a file system 910 to modify the file system. At this point any new ops from the primary storage site that has overlapping byte range will get suspended in OWM queue until the inflight op has released OWM. Upon receiving a successful file system response, data op 2 can now release OWM, and a successful response is sent back to secondary storage site. Data op 2 is then sent to local file system 920 to modify the file system. Upon receiving a successful file system response, data op 2 is good to release OWM on secondary storage site. At this point data op 2 is said to have executed both storage systems and a response can now be sent to client for data op 2. Data op 2 response to client will asynchronously wake up other ops that have been suspended in OWM queue on secondary storage site, if any, and proceed with its execution.

Given an Active/Active storage solution where it is possible to receive read/write requests on overlapping byte range concurrently from both primary and secondary storage sites, there is a possibility of a potential deadlock. The following process in FIGS. 10A and 10B guarantees that the solution does not result in deadlock and preserves dependent write order consistency on each storage system. The solution also tries to maintain the throughput and latency performance profiles during such conflicts from both storage endpoints.

FIGS. 10A and 10B depicts conflict resolution techniques for data op 1 (e.g., W1) arriving on the primary storage site and a concurrent data op 2 (e.g., W2) arriving on the secondary storage site with both of the data ops operating on an overlapping byte range. To start with both data ops 1 and 2 will acquire OWM on primary and secondary storage sites respectively. As per the present design, both data ops would race on to their respective remote storage sites to acquire remote OWM. It is given that this design avoids a potential deadlock by resolving this conflict in such a way that also preserves dependent writer order consistency on each copy of data of the primary and secondary storage sites.

Although the operations in the computer-implemented method 1000 are shown in a particular order, the order of the actions can be modified. Thus, the illustrated embodiments can be performed in a different order, and some operations may be performed in parallel. Some of the operations listed in FIGS. 10A and 10B are optional in accordance with certain embodiments. The numbering of the operations presented is for the sake of clarity and is not intended to prescribe an order of operations in which the various operations must occur. Additionally, operations from the various flows may be utilized in a variety of combinations.

The operations of computer-implemented method 1000 may be executed by a storage controller, a storage virtual machine (e.g., SVM 511a, SVM 511b), a mediator (e.g., mediator 120, mediator 220, mediator 360), a mediator agent (e.g., mediator agent 139a-139n, mediator agent 149a-149n, mediator agent 239a-239n, mediator agent 249a-249n, mediator agent 313, 314, 323, 324, mediator agent 439), a multi-site distributed storage system, a computer system, a machine, a server, a web appliance, a centralized system, a distributed node, or any system, which includes processing logic (e.g., one or more processors, a processing resource). The processing logic may include hardware (circuitry, dedicated logic, etc.), software (such as is run on a general purpose computer system or a dedicated machine or a device), or a combination of both.

Initially, the computer-implemented method includes establishing bi-directional synchronous replication between one or more members of a first storage node of the primary storage site and one or more members of a second storage node of the secondary storage site with each storage node having read/write access while maintaining zero recovery point objective (RPO) and Zero recovery time objective (RTO).

In one embodiment, a multi-site distributed storage system includes a primary storage site (e.g., site A) having a first cluster with a primary copy of data in a consistency group (CG1). The consistency group of the first cluster is initially assigned a primary role. A second cluster of the secondary storage site (e.g., site B) has a secondary mirror copy of the data in a consistency group. The consistency group of the second cluster (CG2) is initially assigned a secondary role. The storage system handles input/output (I/O) requests from the client device having an application.

The primary storage site includes a module 1002 to receive operations from a client, a synchronous replication splitter 1004, a dependent graph manager (DGM) 1006, an overlap write manager 1008, a file system 1010, a scanner 1012, and a writer 1014. In a similar manner, the secondary storage site includes a module 1028 to receive operations from a client, an inflight tracking module 1026, a synchronous replication splitter 1024, a dependent graph manager (DGM) 1023, an overlap write manager 1022, a file system 1020, a scanner 1018, and a writer 1016.

FIGS. 10A and 10B illustrate a conflict resolution technique for primary side data op 1 and secondary side data op 2 that are conflicting over an overlapping region. Both data ops 1 and 2 will succeed in acquiring OWM locally. As per primary-first principle, data op 1 will first modify file system in local file system and proceed further by replicating data op 1 to secondary storage site. Also, data op 2 will be sent to primary first as per the principle.

For example, at operation 1032, a data op 1 is received by module 1002 and sent to synchronous replication splitter 1004. At operation 1034, the synchronous replication splitter 1004 sends a message to DGM 1006 to perform a dependent graph check (e.g., serialize meta and data Ops). At operation 1036, the synchronous replication splitter sends a message to OWM 1008 to perform an overlapping write check (e.g., resolve conflict if data Ops writing to a same range) and the method will succeed in obtaining OWM locally if no conflicting ops are already inflight working on an overlapping byte range.

At operation 1038, a data op 2 is received by module 1028 and sent to synchronous replication splitter 1024. At operation 1040, the synchronous replication splitter 1024 sends a message to DGM 1023 to perform a dependent graph check (e.g., serialize meta and data Ops). At operation 1042, the synchronous replication splitter sends a message to OWM 1022 to perform an overlapping write check (e.g., resolve conflict if data Ops writing to a same range) and it will succeed in obtaining OWM locally if no conflicting ops are already inflight working on an overlapping byte range.

At operation 1044, the synchronous replication splitter sends the data Op 1 to the file system 1010, which generates a response that is sent to the splitter 1004 at operation 1046. At operation 1048, the splitter replicates a response to scanner 1012, which sends the data op 1 to writer 1016 of the secondary storage site at operation 1050. At operation 1052, the splitter 1024 sends the data op 2 to the scanner 1018, which sends the data op 2 to the writer 1014 of the primary storage site at operation 1054.

At operation 1056, the writer 1016 sends a message to DGM 1023 to perform a dependent graph check (e.g., serialize meta and data Ops) for acquiring DGM for data op 1. At operation 1058, the writer sends a message to OWM 1022 to perform an overlapping write check (e.g., resolve conflict if any data Ops writing to a same range) for attempting to acquire OWM for data op 1. At operation 1060, the data op 1 is suspended in OWM queue due to data op 1 and data op 2 having an overlapping range.

At operation 1062, the writer 1014 sends a message to DGM 1006 to perform a dependent graph check (e.g., serialize meta and data Ops) for attempting to acquire DGM for data op 2. At operation 1064, the writer sends a message to OWM 1008 to perform an overlapping write check (e.g., resolve conflict if data Ops writing to a same range) for attempting to acquire OWM for data op 2. At operation 1066, the data op 2 is queued in back off queue due to data op 1 and data op 2 having an overlapping range. At operation 1068, the writer 1014 sends op response to scanner 1018 to indicate that data op 2 has been placed in the back off queue. At operation 1070, the scanner 1018 sends a message to splitter 1024 to add data op 2 to a retry list, which occurs at operation 1072 with the inflight tracker 1026. At operation 1074, the splitter 1024 sends a message to OWM 1022 to release OWM for data op 2. At operation 1076, the splitter 1024 sends a message to DGM 1023 to release DGM for data op 2.

At operation 1078, the OWM 1022 wakes up the previously suspended data op 1. At operation 1080, the writer 1016 sends a message to the file system 1020, which provides a response to the writer at operation 1082. At operation 1084, the writer 1016 releases OWM for data op 1. At operation 1086, the writer 1016 releases DGM for data op 1.

At operation 1088, the writer 1016 sends an op response to scanner 1012, which sends the response to splitter 1004 at operation 1090. At operation 1092, the splitter sends a message to the OWM 1008 to release OWM. At operation 1093, the splitter sends a message to the DGM 1006 to release DGM.

At operation 1094, the splitter 1004 sends a response to client to acknowledge handling of the data op 1. At operation 1095, the OWM 1008 wakes of the data op 2 from the back off queue. At operation 1096, a splitter 1030 sends a retry of data op 2 to splitter 1024. At operation 1097, the splitter 1024 responds to the client after the retry of data op 2.

Returning to operation 1058, data op 1 will try to acquire OWM on the secondary storage site, however it will not succeed because data op 2 has already acquired OWM on the secondary storage site. Conflict resolution technique will put a priority level-0 on data op 1 because data op 1 originated from the primary storage site and suspend itself in OWM queue on the secondary storage site. This technique will avoid a potential deadlock and make sure data op 1 is given precedence over data op 2 such that data op 1 completes its execution in the same round trip time (RTT). At operation 1078, data op 1 will be woken up from the suspended OWM queue on the secondary storage site after data op 2 has given up on the primary storage site.

Data op 2 on similar lines will try to acquire OWM on its remote site that is the primary storage site, however, it will not succeed because data op 1 has already acquired OWM on the primary storage site. Conflict resolution technique will put a priority level-1 on data op 2 because data op 2 originated from the secondary storage site. The algorithm of method 1000 will send a back-off response back to the secondary storage site at operation 1068. Back-off response will queue data op 2 in retry queue so that data op 2 can be retried later. After data op 2 has been put in retry queue, OWM is released from the secondary storage site, which will wake up data op 2 from suspend OWM queue. This will ensure both data ops 1 and 2 avoid a potential deadlock and gives precedence to data op 1 to ensure it completes its execution on both the primary and secondary storage sites in same RTT.

Conflict resolution technique must also make sure data op 2 is not responded with failure to client, instead it is retried before responding. There are challenges with its own trade-offs when it comes to retrying. The present design selects an optimal solution to the conflict resolution technique for handling data op 2 considering throughput, latency, performance, and type of workload matrix

Data op 2 can be retried at exponential back-off intervals, however, this does not reduce the chances of conflict. The present design completes the data op 2 within protocol timeout. Hence, this solution is rejected as it can have adverse effects on throughput and latency.

Data op 2 could also be retried at fixed back-off interval. However, there is a trade-off on what can be fixed back-off interval. If retry is too early, then the method would be wasting resources in retries, and if retry too late, the method will not have a symmetric performance profile for ops arriving on primary and ops arriving on the secondary storage site.

It is preferred to retry data op 2 as soon as the conflict is resolved. This would keep a close throughput and latency performance matrix compared to data op 1. Given the nature of workload for Active/Active solution, this solution has turned out to provide a better result compared to other techniques.

For conflict resolution with immediate retry, when a conflict is detected and resolved, the operation is retried immediately to ensure it is successfully executed without further delay. This technique is explained in the following section through the same example of data op 2.

In a concurrently executing ops from multi-site storage solution where data op 1 arrives on the primary storage site and data op 2 arrives on the secondary storage site, data op 2 will proceed and acquire OWM locally on the secondary storage site. As per primary-first principle, data op 2 is now sent to primary storage site before it modifies local file system. Data op 2 will try to acquire OWM on primary storage site, however, data op 2 will fail to do so since a conflicting data op 1 has already acquired OWM on primary storage site. Since data op 2 has priority level-1 set, the method will send a back-off response so that data op 2 can be retried again from secondary retry-list. Before sending a back-off response, data op 1 puts its identity denoted by sequence number into OWM back-off queue. OWM back-off queue is defined by back-off ops with priority level-1 that are wait-listed behind an inflight conflicting op. Once data op 2 has released its local OWM on primary storage site, the method wakes up ops from OWM back-off queue as a conflicting op has ended its execution. As part of post Op Wake Up OWM Backoff Op, the method notifies the secondary storage site that the conflict has been resolved on primary and the conditions are good for data op 2 to be retried. This immediate retry will ensure data op 2 need not be delayed when the conditions are good for data op 2 to complete its execution on both storage endpoints. The notify call will carry data op 2's identity (e.g., sequence number) to retry module (hereafter referred to as IFTT) on the secondary storage site for it to identify which op needs a retry. IFTT without any further delay will then retry data op 2 with a new sequence number and can complete its execution this time on both storage systems preserving write order consistency.

A Distributed Inode Dependency Graph Manager (DGM) is designed to handle the bidirectional replication of Inode dependent operations in the active-active storage solution. This is similar to the Distributed Overlapping Writes Manager (OWM), but it focuses on managing dependencies at an Inode level rather than byte ranges. An inode (index node) is a data structure in a Unix-style file system that describes a file-system object such as a file or a directory. Each inode stores the attributes and disk block locations of the object's data. File-system object attributes may include metadata, as well as owner and permission data. Inodes can include a file size, a device on which the file is stored, user and group IDs associated with the file, permissions needed to access the file, creation, read, and write timestamps, and location of the data.

A primary storage site can receive both data operations (e.g., write, punch-hole, etc.) and metadata operations (e.g., file create, open, set-attribute, resize, link, rename, clone, delete, etc.). The secondary storage site, however, only replicates data operations. Metadata operations received by the secondary storage site are proxied to the primary storage site and treated as primary-side operations for replication. This simplifies the design.

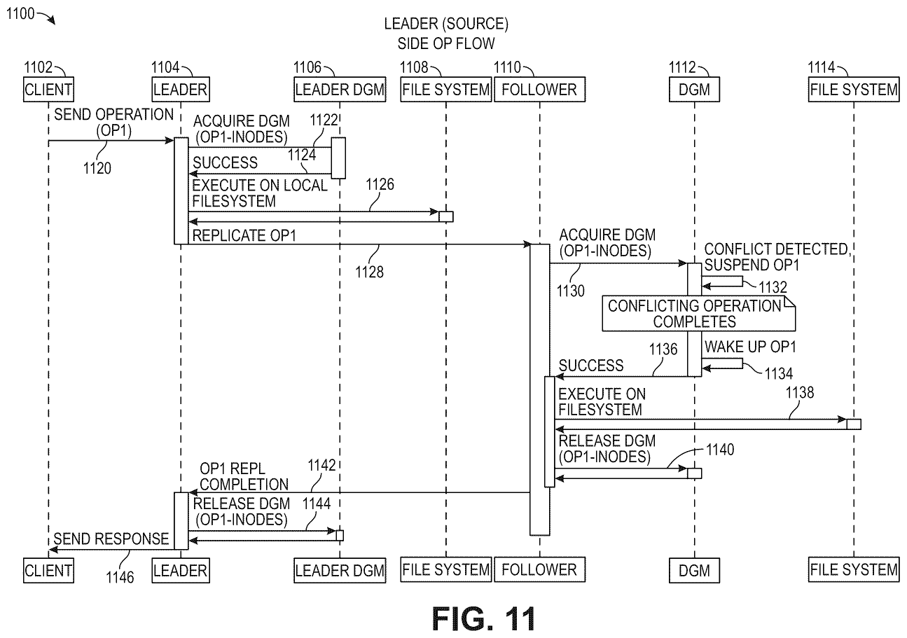

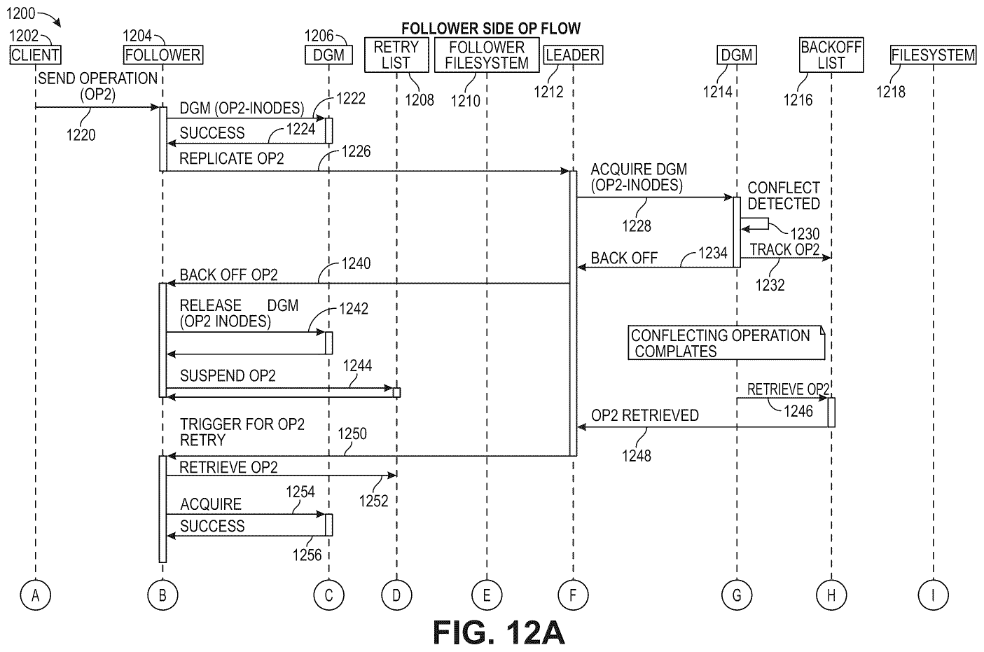

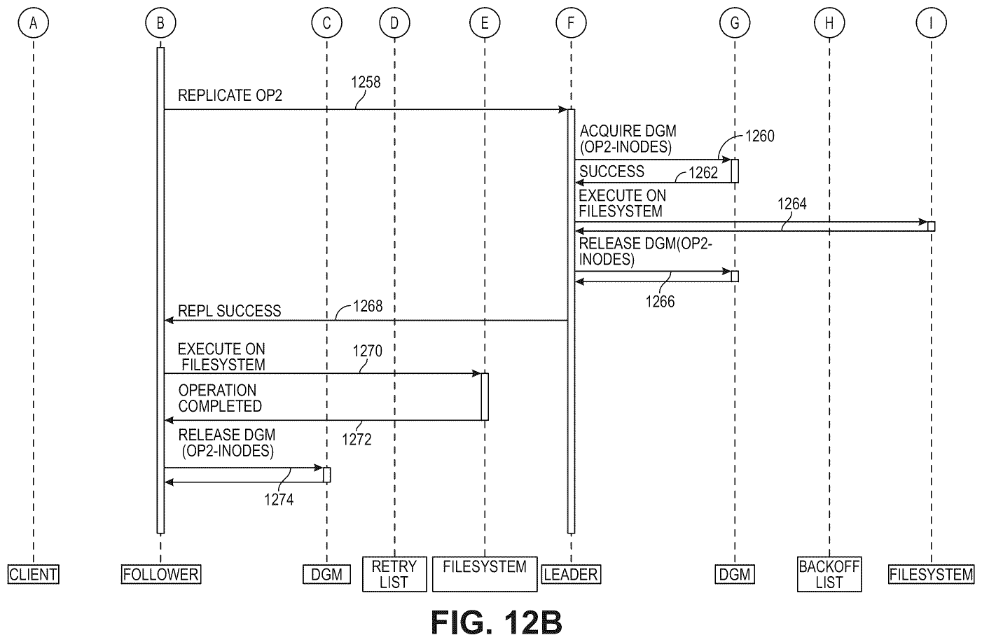

Operations are executed following the primary-first principle, meaning the ops are first executed on the primary storage site and then on the secondary storage site. The DGM serializes operations that are dependent at an Inode level. If a data operation for an Inode is in progress, a metadata operation for the same Inode is suspended. Similarly, if a data operation or another metadata operation for an Inode is in progress, a metadata operation for the same Inode is suspended. The specific flow of primary-side ops and secondary-side ops are illustrated with examples of FIGS. 11 and 12 below.

### Primary Side Data Flow

FIG. 11 illustrates a flow diagram for a computer-implemented method of a primary side data flow for bidirectional replication of inode dependent operations for a symmetric distributed storage system having Active/Active bi-directional synchronous replication in accordance with an embodiment of the present disclosure. State information regarding members (e.g., storage volumes) of a local CG can be maintained. The state information may include a data replication status of a mirror copy of a dataset associated with a local CG (e.g., CG 515a) may be maintained, for example, to facilitate automatic triggering of resynchronization. For example, the state information may include information relating to the current availability or unavailability of a peer volume of a remote CG corresponding to a member volume of the local CG and/or the data replication state of the local CG. In one embodiment, the state information may track the current state of a given CG and a given volume consistent with the state diagrams of FIG. 6A and FIG. 6B.

Although the operations in the computer-implemented method 900 are shown in a particular order, the order of the actions can be modified. Thus, the illustrated embodiments can be performed in a different order, and some operations may be performed in parallel. Some of the operations listed in FIG. 11 are optional in accordance with certain embodiments. The numbering of the operations presented is for the sake of clarity and is not intended to prescribe an order of operations in which the various operations must occur. Additionally, operations from the various flows may be utilized in a variety of combinations.

The operations of computer-implemented method 1100 may be executed by a storage controller, a storage virtual machine (e.g., SVM 511a, SVM 511b), a mediator (e.g., mediator 120, mediator 220, mediator 360), a mediator agent (e.g., mediator agent 139a-139n, mediator agent 149a-149n, mediator agent 239a-239n, mediator agent 249a-249n, mediator agent 313, 314, 323, 324, mediator agent 439), a multi-site distributed storage system, a computer system, a machine, a server, a web appliance, a centralized system, a distributed node, or any system, which includes processing logic (e.g., one or more processors, a processing resource). The processing logic may include hardware (circuitry, dedicated logic, etc.), software (such as is run on a general purpose computer system or a dedicated machine or a device), or a combination of both.

Initially, the computer-implemented method includes establishing bi-directional synchronous replication between one or more members of a first storage node of the primary storage site and one or more members of a second storage node of the secondary storage site with each storage node having read/write access while maintaining zero recovery point objective (RPO) and Zero recovery time objective (RTO).

In one embodiment, a multi-site distributed storage system includes a primary storage site (e.g., site A) having a first cluster with a primary copy of data in a consistency group (CG1). The consistency group of the first cluster is initially assigned a primary role. A second cluster of the secondary storage site (e.g., site B) has a secondary mirror copy of the data in a consistency group. The consistency group of the second cluster (CG2) is initially assigned a secondary role. The storage system handles input/output (I/O) requests from the client device having an application.

The primary storage site includes a leader module 1104 to receive operations from a client 1102, a distributed Inode dependent graph manager (DGM) 1106, and a file system 1108. In a similar manner, the secondary storage site includes a follower module 1110 to interface with the primary storage site, a distributed Inode dependent graph manager (DGM) 1112, and a file system 1114.

At operation 1120, a primary-side operation (e.g., OP1) is received at leader 1104 from client 1102 and then the leader 1104 sends a message to DGM 1106 at operation 1122 to first acquire a local DGM lock for inode(s) of OP1. At operation 1124, the DGM 1106 sends a success message to leader 1104. At operation 1126, the OP1 then gets executed on the local file system 1108. After this, at operation 1128, OP1 is replicated to the follower 1110 of the secondary storage site, where it acquires a DGM lock for inode(s) of OP1 on the secondary storage site using DGM 1112 at operation 1130. OP1 then gets executed on the file system 1114 unless a conflict is detected at operation 1132 that suspends OP1.

At operation 1134, OP1 wakes up after a conflicting operation completes. At operation 1136, the DGM 1112 sends a success message to follower 1110. At operation 1138, the OP1 executes on file system 1114. After execution, the method releases the DGM lock on the secondary at operation 1140, sends OP1 replication completion to leader 1104 at operation 1142, and finally releases the DGM lock for inode(s) of OP1 on the primary storage site at operation 1144 before responding to the client at operation 1146. During this process, OP1 can be suspended on the primary and/or on the secondary storage site if a conflicting operation is in progress.

### Secondary Side Data Flow

FIGS. 12A and 12B illustrate a flow diagram for a computer-implemented method of a secondary side data flow for bidirectional replication of Inode dependent operations for a symmetric distributed storage system having Active/Active bi-directional synchronous replication in accordance with an embodiment of the present disclosure. State information regarding members (e.g., storage volumes) of a local CG can be maintained. The state information may include a data replication status of a mirror copy of a dataset associated with a local CG (e.g., CG 515a) may be maintained, for example, to facilitate automatic triggering of resynchronization. For example, the state information may include information relating to the current availability or unavailability of a peer volume of a remote CG corresponding to a member volume of the local CG and/or the data replication state of the local CG. In one embodiment, the state information may track the current state of a given CG and a given volume consistent with the state diagrams of FIG. 6A and FIG. 6B.

Although the operations in the computer-implemented method 900 are shown in a particular order, the order of the actions can be modified. Thus, the illustrated embodiments can be performed in a different order, and some operations may be performed in parallel. Some of the operations listed in FIGS. 12A and 12B are optional in accordance with certain embodiments. The numbering of the operations presented is for the sake of clarity and is not intended to prescribe an order of operations in which the various operations must occur. Additionally, operations from the various flows may be utilized in a variety of combinations.

The operations of computer-implemented method 1200 may be executed by a storage controller, a storage virtual machine (e.g., SVM 511a, SVM 511b), a mediator (e.g., mediator 120, mediator 220, mediator 360), a mediator agent (e.g., mediator agent 139a-139n, mediator agent 149a-149n, mediator agent 239a-239n, mediator agent 249a-249n, mediator agent 313, 314, 323, 324, mediator agent 439), a multi-site distributed storage system, a computer system, a machine, a server, a web appliance, a centralized system, a distributed node, or any system, which includes processing logic (e.g., one or more processors, a processing resource). The processing logic may include hardware (circuitry, dedicated logic, etc.), software (such as is run on a general purpose computer system or a dedicated machine or a device), or a combination of both.

Initially, the computer-implemented method includes establishing bi-directional synchronous replication between one or more members of a first storage node of the primary storage site and one or more members of a second storage node of the secondary storage site with each storage node having read/write access while maintaining zero recovery point objective (RPO) and Zero recovery time objective (RTO).

In one embodiment, a multi-site distributed storage system includes a primary storage site (e.g., site A) having a first cluster with a primary copy of data in a consistency group (CG1). The consistency group of the first cluster is initially assigned a primary/leader role. A second cluster of the secondary storage site (e.g., site B) has a secondary mirror copy of the data in a consistency group. The consistency group of the second cluster (CG2) is initially assigned a secondary/follower role. The storage system handles input/output (I/O) requests from the client device having an application.

The primary storage site includes a leader module 1212 to interface with a follower module 1204, a backoff list queue 1216, and file system 1218. The secondary storage site includes a follower module 1204, a distributed Inode dependent graph manager (DGM) 1206, a retry list queue 1208, and a file system 1210.

At operation 1220, a primary-side operation (e.g., OP2) is received at follower module 1204 from client 1202 and then the leader 1104 sends a message to DGM 1206 at operation 1222 to first acquire a local DGM lock for inode(s) for the OP2. At operation 1224, the DGM 1206 sends a success message to follower module 1204. At operation 1226, the OP2 then gets replicated to leader module 1212, which sends a message to DGM 1214 to acquire a local DGM lock for the inode(s) for OP2 at operation 1228 if no conflict is detected. However, if a conflict is detected at operation 1230, then a track OP2 message is sent to the backoff list queue 1216 at operation 1232. At operation 1234, the DGM 1214 sends a backoff to the leader module 1212, which sends a backoff for OP2 to the follower module 1204 at operation 1240. At operation 1242, the follower module 1204 sends a message to DGM to release DGM lock for the OP2 inode(s). At operation 1244, OP2 is suspended.

After a conflicting operation completes, the DGM sends a message to backoff list 1216 to retrieve OP2 at operation 1246. In response, OP2 is retrieved and sent to leader module 1212 at operation 1248.

At operation 1250, the leader module 1212 sends a message to initiate OP2 retry at follower module 1204. In response, OP2 is retrieved from retry list queue 1208 at operation 1252. At operation 1254, the follower module 1204 attempts to acquire DGM lock from DGM 1206 for OP2 inodes. At operation 1256, a success message is sent to follower module 1204. This triggers replication of OP2 to the leader module 1212 at operation 1258, where it acquires a DGM lock on the OP2 inode(s) using DGM 1214 at operation 1260. A success message is sent to leader module 1212 at operation 1262. OP2 then gets executed on the file system 1218 at operation 1264 unless a conflict is detected.

After execution, the method releases the DGM lock on the OP2 inode(s) at operation 1266, sends OP2 replication completion to follower module 1204 at operation 1268, executes OP2 on file system 1210 at operation 1270, operation completes at operation 1272, and finally releases the DGM lock on the OP2 inode(s) at operation 1274 before responding to the client at operation 1276.

A secondary-side operation (e.g., OP2) first acquires a DGM lock on the secondary storage site. It then gets sent to the primary storage site, where it tries to acquire a DGM lock on the primary storage site. If there are no conflicting ops, DGM locking is successful, and it proceeds to execute on the primary storage site file system. After execution, it releases the DGM lock on the primary storage site, comes back to the secondary storage site, gets executed on the secondary storage site's file system, and finally releases the DGM lock on the secondary storage site before responding to the client. If OP2 finds a conflicting operation in progress at the primary storage site, it is added to a back-off list and returns to secondary with a special back-off error. The secondary storage site releases the DGM lock on the secondary storage site and adds it to a retry list. The DGM unlock allows the conflicting primary operation if any to proceed on the secondary storage site if it was suspended. Once the conflicting operation is complete, the primary storage site retrieves the backed-off operation from the backoff-list and sends a trigger to the secondary to retry OP2. Upon retry, OP2 will run to completion provided there are no conflicting ops.

### Example Computer System

Embodiments of the present disclosure include various steps, which have been described above. The steps may be performed by hardware components or may be embodied in machine-executable instructions, which may be used to cause a processing resource (e.g., a general-purpose or special-purpose processor) programmed with the instructions to perform the steps. Alternatively, depending upon the particular implementation, various steps may be performed by a combination of hardware, software, firmware and/or by human operators.

Embodiments of the present disclosure may be provided as a computer program product, which may include a non-transitory machine-readable storage medium embodying thereon instructions, which may be used to program a computer (or other electronic devices) to perform a process. The machine-readable medium (or non-transitory computer-readable medium) may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more non-transitory machine-readable storage media containing the code according to embodiments of the present disclosure with appropriate special purpose or standard computer hardware to execute the code contained therein. An apparatus for practicing various embodiments of the present disclosure may involve one or more computers (e.g., physical and/or virtual servers) (or one or more processors within a single computer) and storage systems containing or having network access to computer program(s) coded in accordance with various methods described herein, and the method steps associated with embodiments of the present disclosure may be accomplished by modules, routines, subroutines, or subparts of a computer program product.

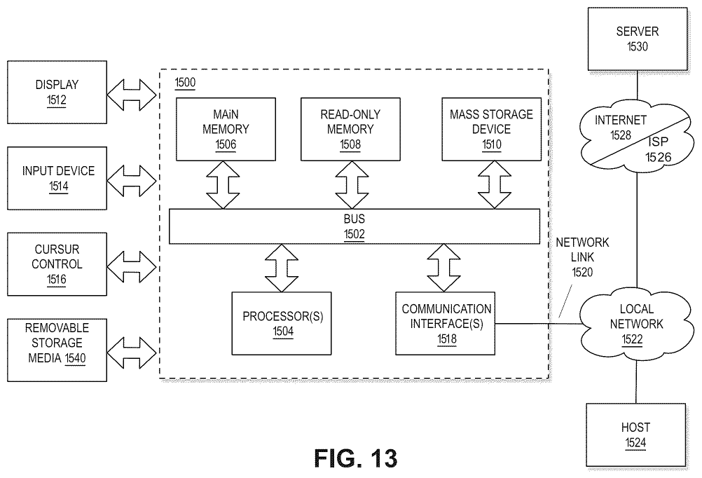

FIG. 13 is a block diagram that illustrates a computer system 1500 in which or with which an embodiment of the present disclosure may be implemented. Computer system 1500 may be representative of all or a portion of the computing resources associated with a storage node (e.g., storage node 136a-n, storage node 146a-n, storage node 156a-b, storage node 236a-n, storage node 246a-n, nodes 311-312, nodes 321-322, nodes 356a-356b, storage node 400), a mediator (e.g., mediator 120, mediator 220, mediator 360), or an administrative workstation (e.g., computer system 110, computer system 210). Notably, components of computer system 1500 described herein are meant only to exemplify various possibilities. In no way should example computer system 1500 limit the scope of the present disclosure. In the context of the present example, computer system 1500 includes a bus 1502 or other communication mechanism for communicating information, and a processing resource (e.g., processing logic, hardware processor(s) 1504) coupled with bus 1502 for processing information. Hardware processor 504 may be, for example, a general purpose microprocessor.

Computer system 1500 also includes a main memory 1506, such as a random access memory (RAM) or other dynamic storage device, coupled to bus 1502 for storing information and instructions to be executed by processor 1504. Main memory 1506 also may be used for storing temporary variables or other intermediate information during execution of instructions to be executed by processor 1504. Such instructions, when stored in non-transitory storage media accessible to processor 1504, render computer system 1500 into a special-purpose machine that is customized to perform the operations specified in the instructions.

Computer system 1500 further includes a read only memory (ROM) 1508 or other static storage device coupled to bus 1502 for storing static information and instructions for processor 1504. A storage device 1510, e.g., a magnetic disk, optical disk or flash disk (made of flash memory chips), is provided and coupled to bus 1502 for storing information and instructions.

Computer system 1500 may be coupled via bus 1502 to a display 1512, e.g., a cathode ray tube (CRT), Liquid Crystal Display (LCD), Organic Light-Emitting Diode Display (OLED), Digital Light Processing Display (DLP) or the like, for displaying information to a computer user. An input device 1514, including alphanumeric and other keys, is coupled to bus 1502 for communicating information and command selections to processor 1504. Another type of user input device is cursor control 1516, such as a mouse, a trackball, a trackpad, or cursor direction keys for communicating direction information and command selections to processor 1504 and for controlling cursor movement on display 1512. This input device typically has two degrees of freedom in two axes, a first axis (e.g., x) and a second axis (e.g., y), that allows the device to specify positions in a plane.

Removable storage media 1540 can be any kind of external storage media, including, but not limited to, hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM), USB flash drives and the like.

Computer system 1500 may implement the techniques described herein using customized hard-wired logic, one or more ASICs or FPGAs, firmware or program logic which in combination with the computer system causes or programs computer system 1500 to be a special-purpose machine. According to one embodiment, the techniques herein are performed by computer system 1500 in response to processor 1504 executing one or more sequences of one or more instructions contained in main memory 1506. Such instructions may be read into main memory 1506 from another storage medium, such as storage device 1510. Execution of the sequences of instructions contained in main memory 1506 causes processor 1504 to perform the process steps described herein. In alternative embodiments, hard-wired circuitry may be used in place of or in combination with software instructions.

The term “storage media” as used herein refers to any non-transitory media that store data or instructions that cause a machine to operation in a specific fashion. Such storage media may comprise non-volatile media or volatile media. Non-volatile media includes, for example, optical, magnetic or flash disks, such as storage device 1510. Volatile media includes dynamic memory, such as main memory 1506. Common forms of storage media include, for example, a flexible disk, a hard disk, a solid state drive, a magnetic tape, or any other magnetic data storage medium, a CD-ROM, any other optical data storage medium, any physical medium with patterns of holes, a RAM, a PROM, and EPROM, a FLASH-EPROM, NVRAM, a non-transitory computer-readable storage medium, or any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1502. Transmission media can also take the form of acoustic or light waves, such as those generated during radio-wave and infra-red data communications.

Various forms of media may be involved in carrying one or more sequences of one or more instructions to processor 1504 for execution. For example, the instructions may initially be carried on a magnetic disk or solid state drive of a remote computer. The remote computer can load the instructions into its dynamic memory and send the instructions over a telephone line using a modem. A modem local to computer system 1500 can receive the data on the telephone line and use an infra-red transmitter to convert the data to an infra-red signal. An infra-red detector can receive the data carried in the infra-red signal and appropriate circuitry can place the data on bus 1502. Bus 1502 carries the data to main memory 1506, from which processor 1504 retrieves and executes the instructions. The instructions received by main memory 1506 may optionally be stored on storage device 1510 either before or after execution by processor 1504.

Computer system 1500 also includes a communication interface 1518 coupled to bus 1502. Communication interface 1518 provides a two-way data communication coupling to a network link 1520 that is connected to a local network 1522. For example, communication interface 1518 may be an integrated services digital network (ISDN) card, cable modem, satellite modem, or a modem to provide a data communication connection to a corresponding type of telephone line. As another example, communication interface 1518 may be a local area network (LAN) card to provide a data communication connection to a compatible LAN. Wireless links may also be implemented. In any such implementation, communication interface 1518 sends and receives electrical, electromagnetic or optical signals that carry digital data streams representing various types of information.

Network link 1520 typically provides data communication through one or more networks to other data devices. For example, network link 1520 may provide a connection through local network 1522 to a host computer 1524 or to data equipment operated by an Internet Service Provider (ISP) 1526. ISP 1526 in turn provides data communication services through the world wide packet data communication network now commonly referred to as the “Internet” 1528. Local network 1522 and Internet 1528 both use electrical, electromagnetic or optical signals that carry digital data streams. The signals through the various networks and the signals on network link 1520 and through communication interface 1518, which carry the digital data to and from computer system 1500, are example forms of transmission media.

Computer system 1500 can send messages and receive data, including program code, through the network(s), network link 1520 and communication interface 1518. In the Internet example, a server 1530 might transmit a requested code for an application program through Internet 1528, ISP 1526, local network 1522 and communication interface 1518. The received code may be executed by processor 1504 as it is received, or stored in storage device 1510, or other non-volatile storage for later execution.

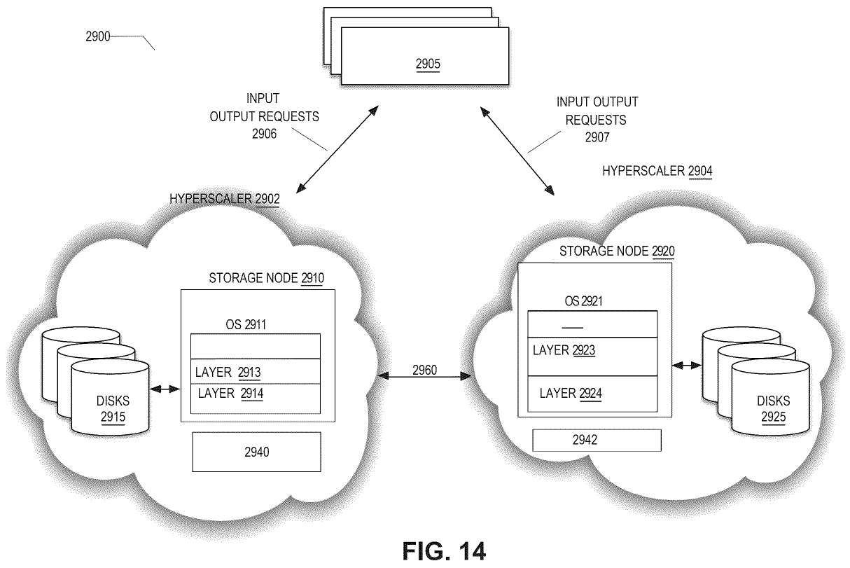

FIG. 14 is a block diagram illustrating a cloud environment in which various embodiments may be implemented (e.g., virtual storage nodes of a primary storage site, a secondary storage site, and a tertiary storage site). In various examples described herein, a virtual storage system 2900 may be run (e.g., on a VM or as a containerized instance, as the case may be) within a public cloud provider (e.g., hyperscaler 2902, 2904). In the context of the present example, the virtual storage system 2900 includes virtual storage nodes 2910 and 2920 and makes use of cloud disks (e.g., hyperscale disks 2915, 2925) provided by the hyperscaler.

The virtual storage system 2900 may present storage over a network to clients 2905 using various protocols (e.g., object storage protocol (OSP), small computer system interface (SCSI), Internet small computer system interface (ISCSI), fibre channel (FC), common Internet file system (CIFS), network file system (NFS), hypertext transfer protocol (HTTP), web-based distributed authoring and versioning (WebDAV), or a custom protocol. Clients 2905 may request services of the virtual storage system 2900 by issuing Input/Output requests 2906, 2907 (e.g., file system protocol messages (in the form of packets) over the network). A representative client of clients 2905 may comprise an application, such as a database application, executing on a computer that “connects” to the virtual storage system over a computer network, such as a point-to-point channel, a shared local area network (LAN), a wide area network (WAN), or a virtual private network (VPN) implemented over a public network, such as the Internet.

In the context of the present example, the virtual storage system 2900 includes virtual storage nodes 2910 and 2920 with each virtual storage node being shown includes an operating system. The virtual storage node 2910 includes an operating system 2911 having layers 2913 and 2914 of a protocol stack for processing of object storage protocol operations or requests.

The virtual storage node 2920 includes an operating system 2921, layers 2923 and 2924 of a protocol stack for processing of object storage protocol operations or requests.

The storage nodes can include storage device drivers for transmission of messages and data via the one or more links 2960. The storage device drivers interact with the various types of hyperscale disks 2915, 2925 supported by the hyperscalers.

The data served by the virtual storage nodes may be distributed across multiple storage units embodied as persistent storage devices (e.g., non-volatile memory 2940, 2942), including but not limited to HDDs, SSDs, flash memory systems, or other storage devices (e.g., 2915, 2925).

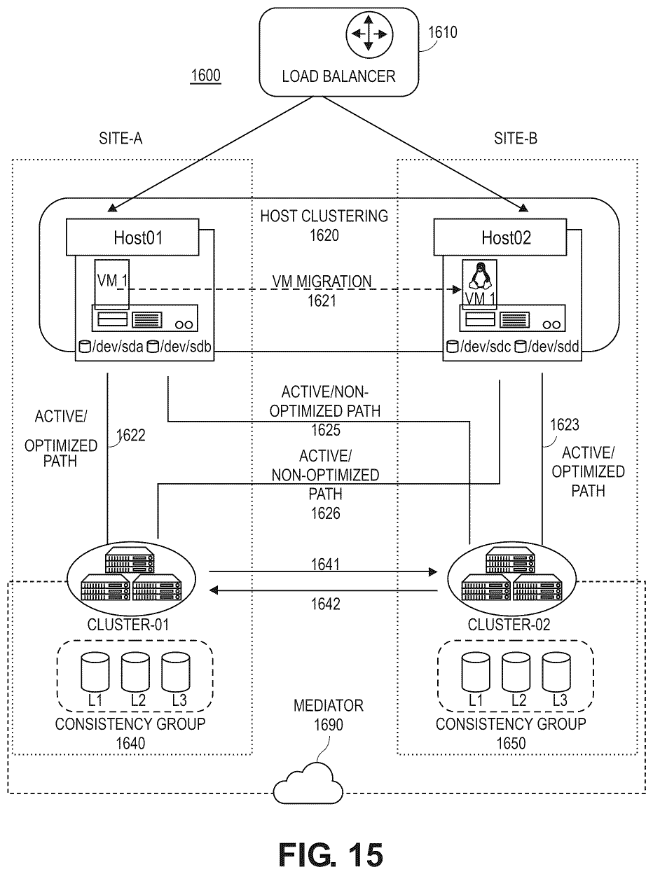

FIG. 15 is a block diagram illustrating a virtualized environment in which various embodiments may be implemented (e.g., virtual storage nodes of a primary storage site, a secondary storage site, etc.). In various examples described herein, a virtual storage system 1600 may be run (e.g., on a VM or as a containerized instance, as the case may be) within a public cloud provider. In the context of the present example, the virtual storage system 1600 includes a management server appliance 1610, a host clustering 1620 that includes host 01 and a host 02, and clusters 01 and 02. Cluster 01 includes a consistency group 1240 with L1, L2, and L3. Cluster 02 includes a consistency group 1650 with L1, L2, and L3.

To create a virtualized high availability host clustering 1620 across two sites A and B, hosts are used and managed by a server appliance 1610. The virtual machine (VM-1) can be migrated with VM migration 1621 from host 01 to host 02. The server appliance 1610 is a centralized management system that enables administrators to effectively operate hosts in host clusters. The server appliance 1610 facilitates key functions such as VM provisioning, High Availability (HA), Distributed Resource Scheduler (DRS), Kubernetes Grid, and more. It is an important component in cloud environments.

The virtual storage system 1600 provides advanced business continuity if one or more failure domains suffer a total outage. The virtual storage system 1600 may present storage over a network to clients using various protocols (e.g., object storage protocol (OSP), small computer system interface (SCSI), Internet small computer system interface (ISCSI), fibre channel (FC), common Internet file system (CIFS), network file system (NFS), hypertext transfer protocol (HTTP), web-based distributed authoring and versioning (WebDAV), or a custom protocol. Clients may request services of the virtual storage system 1600 by issuing Input/Output requests (e.g., file system protocol messages (in the form of packets) over the network). A representative client may comprise an application, such as a database application, executing on a computer that “connects” to the virtual storage system over a computer network, such as a point-to-point channel, a shared local area network (LAN), a wide area network (WAN), or a virtual private network (VPN) implemented over a public network, such as the Internet.

In the context of the present example, the clusters 01 and 02 each include virtual storage nodes with each virtual storage node including an operating system. The storage nodes can include storage device drivers for transmission of messages and data via the one or more links 1641 and 1642.

The data served by the virtual storage nodes may be distributed across multiple storage units embodied as persistent storage devices (e.g., non-volatile memory), including but not limited to HDDs, SSDs, flash memory systems, or other storage devices.

The clusters 01 and 02 enable business services to continue operating even through a complete site failure, supporting applications to fail over transparently using a secondary copy. Neither manual intervention nor custom scripting are required to trigger a failover with active sync. The active sync supports a symmetric active active capability, enabling read and write I/O operations from both copies of a protected LUN (e.g., L1, L2, L3) with bidirectional synchronous replication, enabling both LUN copies to serve I/O operations locally.

A data protection relationship to protect for business continuity is created between the source storage system (e.g., cluster 01) and destination storage system (e.g., cluster 02), by adding the application specific LUNs from different volumes within a storage virtual machine (SVM) to the consistency group. Under normal operations, the enterprise application writes to the primary consistency group (e.g., CG 1640), which synchronously replicates this I/O to the mirror consistency group (e.g., CG 1650). Even though two separate copies of the data exist in the data protection relationship, because active sync maintains the same LUN identity, the application host sees this as a shared virtual device with multiple paths (e.g., active/optimized paths 1622, 1623; active/non-optimized path 1625, 1626) while only one LUN copy is being written to at a time. Active Optimized paths are a path state in ALUA (Asymmetric Logical Unit Access) where the target storage system responds to I/O requests using the most efficient path. In this case, the active/optimized path 1622 is between host 01 and cluster 01 at site A while the active/optimized path 1623 is between host 02 and cluster 02 at site B. The active non-optimized paths 1625 and 1626 are between different sites. This results in higher performance and reduced latency.

When a failure renders the primary storage system offline, the operating system detects this failure and uses the Mediator 1690 for reconfirmation. If neither the operating system nor the Mediator 1690 are able to ping the primary site with cluster 01, the operating system performs the automatic failover operation. This process results in failing over only a specific application without the need for the manual intervention or scripting which was previously required for the purpose of failover.

The external Mediator 1690 is external from sites A and B and installed in a third failure domain, distinct from the two distinct failure domains of the clusters 01 and 02. The Mediator 1690 acts as a passive witness to active sync copies. In the event of a network partition or unavailability of one copy, active sync uses Mediator 1690 to determine which copy continues to serve I/O, while discontinuing I/O on the other copy. The Mediator 1690 plays a crucial role in active sync configurations as a passive quorum witness, ensuring quorum maintenance and facilitating data access during failures. It acts as a ping proxy for controllers to determine liveliness of peer controllers. Although the Mediator does not actively trigger switchover operations, it provides a vital function by allowing the surviving node to check its partner's status during network communication issues. In its role as a quorum witness, the Mediator provides an alternate path (effectively serving as a proxy) to the peer cluster.

Furthermore, the Mediator allows clusters to get this information as part of the quorum process. The Mediator 1690 utilizes the node management LIF and cluster management LIF for communication purposes. The Mediator 1690 establishes redundant connections through multiple paths to differentiate between site failure and InterSwitch Link (ISL) failure. When a cluster loses connection with the Mediator software and all its nodes due to an event, it is considered not reachable. This triggers an alert and enables automated failover to the mirror Consistency Group (CG) in the secondary site, ensuring uninterrupted I/O for the client. The replication data path relies on a heartbeat mechanism, and if a network glitch or event persists beyond a certain period, it can result in heartbeat failures, causing the relationship to go out-of-sync. However, the presence of redundant paths, such as LIF failover to another port, can sustain the heartbeat and prevent such disruptions.

1. A computer-implemented method of primary side first sequential split operations comprising:
establishing bi-directional synchronous replication between a primary copy of data of one or more members of a first consistency group (CG1) of a primary storage site and a secondary copy of the data of one or more members of a second consistency group (CG2) of a secondary storage site with each storage site having concurrent read/write access for serving inflight input/output (I/O) operations while maintaining zero recovery point objective (RPO) and Zero recovery time objective (RTO);
implementing primary-First principle with a first data Op received by the primary storage site being executed on the primary storage site and then replicated to the secondary storage site and a second data Op received by the secondary storage site being first performing an overlapping write check on the secondary storage site to resolve a conflict if any other data Ops are writing to a same byte range of the secondary copy of data, replicated to the primary storage site subsequently, performing an overlap write check to resolve a conflict if any other data Ops writing to a same byte range as the second data Op on the primary copy of data on the primary storage site, sending the second data Op to a file system to execute the second data Op on the primary copy of data if no overlapping write conflict on the primary copy of data, sending an Op response from the primary storage site to the secondary storage site, and then executing the second data Op locally on the secondary copy of the data of the secondary storage site based on receiving the Op response from the primary storage site;
acquiring overlap write manager (OWM) lock locally on the primary storage site for the first data Op if there are no conflicting Ops that are already inflight working on an overlapping range;
sending the first data Op to a file system of the primary storage site to modify the file system as per primary-first principle; and
suspending any new Ops from the primary storage site that have an overlapping byte range that overlaps with a byte range of the first data Op.

2. The computer-implemented method of claim 1, further comprising:
upon receiving a successful response from the file system, replicating the first data Op to the secondary storage site, wherein the first consistency group of the primary storage site is initially assigned a primary role for serving the I/O operations and the second consistency group of the secondary storage site is initially assigned a secondary role for serving the I/O operations.

3. The computer-implemented method of claim 2, further comprising:
acquiring overlap write manager (OWM) lock locally on the secondary storage site for the first data Op if there are no conflicting Ops that are already inflight working on an overlapping range of the first data Op;
sending the first data Op to a file system of the secondary storage site to modify the file system as per primary-first principle; and
suspending any new Ops from the secondary storage site that have an overlapping range that overlaps with a range of the first data Op.

4. The computer-implemented method of claim 3, further comprising:
upon receiving a successful response from the file system of the secondary storage site, releasing the OWM lock on the secondary storage site.

5. The computer-implemented method of claim 2, further comprising:
sending a response of the replicated first data Op to the primary storage site; and
releasing the OWM lock on the primary storage site based on receiving the response of the replicated first data Op.

6. The computer-implemented method of claim 1, further comprising:
sending a response to a client device after the first data Op is executed on the primary and secondary storage sites; and
asynchronously wake up other Ops that have been suspended in an OWM queue on the primary storage site, if any, and proceed with execution of the other Ops.

7. The computer-implemented method of claim 1, wherein the first data Op and the second data Op are serialized with the OWM on both primary and secondary storage sites to ensure ordering of overlapping data Ops.

8. A non-transitory computer-readable storage medium embodying a set of instructions, which when executed by one or more processing resources of a distributed storage system, cause the one or more processing resources to:
establishing bi-directional synchronous replication between a primary copy of data of one or more members of a first consistency group (CG1) of a primary storage site and a secondary copy of the data of one or more members of a second consistency group (CG2) of a secondary storage site with each storage site having concurrent read/write access for serving inflight input/output (I/O) operations while maintaining zero recovery point objective (RPO) and Zero recovery time objective (RTO);
implement primary-First principle with a first data Op received by the primary storage site being executed on the primary storage site and then replicated to the secondary storage site and a second data Op received by the secondary storage site being first performing an overlapping write check on the secondary storage site to resolve a conflict if any other data Ops are writing to a same byte range of the secondary copy of data, replicated to the primary storage site subsequently, performing an overlap write check to resolve a conflict if any other data Ops writing to a same byte range as the second data Op on the primary copy of data on the primary storage site;
acquire overlap write manager (OWM) lock locally on the primary storage site for the first data Op if there are no conflicting Ops that are already inflight working on an overlapping range;
send the first data Op to a file system of the primary storage site to modify the file system as per primary-first principle; and
suspend any new Ops including the second data Op in a back off queue that have an overlapping byte range that overlaps with a byte range of the first data Op.

9. The non-transitory computer-readable storage medium of claim 8, wherein the instructions further cause the one or more processing resources to:
upon receiving a successful response from the file system, replicate the first data Op to the secondary storage site.

10. The non-transitory computer-readable storage medium of claim 9, wherein the instructions further cause the one or more processing resources to:
acquire overlap write manager (OWM) lock locally on the secondary storage site for the first data Op if there, are no conflicting Ops that are already inflight working on an overlapping range of the first data Op; and
send an Op response to secondary storage site to indicate that the second data Op has been placed in the back off queue.

11. The non-transitory computer-readable storage medium of claim 10, wherein the instructions further cause the one or more processing resources to:
send a message to a synchronous replication splitter to add the second data Op to a retry list;
send a message to an overlap write manager (OWM) to release the OWM lock for the second data Op;
acquiring a dependent graph manager (DGM) lock for the second data Op; and
send a message to dependent graph manager (DGM) to release the DGM lock for the second data Op.

12. The non-transitory computer-readable storage medium of claim 11, wherein the instructions further cause the one or more processing resources to:
suspend the first data Op at the secondary storage site if a conflict occurs;
wake up the first data Op from being suspended on the secondary storage site;
release the OWM lock for the first data Op;
acquiring a DGM lock for the first data Op; and
release the DGM lock for the first data Op.

13. The non-transitory computer-readable storage medium of claim 8, wherein the instructions further cause the one or more processing resources to:
wake up the second data op from the back off queue;
send a retry of the second data Op on the secondary storage site; and
respond to a client after the retry of the second data Op.

14. The non-transitory computer-readable storage medium of claim 8, wherein the instructions further cause the one or more processing resources to:
assign a first priority level to the first data Op because the data Op originated on the primary storage site and assign a second priority level to the second data Op due to the second data Op originating on the secondary storage site.

15. A distributed storage system comprising:
one or more processing resources; and
one or more non-transitory computer-readable medium, coupled to the one or more processing resources, having stored therein instructions that when executed by the one or more processing resources cause the one or more processing resources to:
establish bi-directional synchronous replication between a primary copy of data of one or more members of a first consistency group (CG1) of a primary storage site and a secondary copy of data of one or more members of a second consistency group (CG2) of a secondary storage site with each site having concurrent read/write access for serving inflight input/output (I/O) operations while maintaining zero recovery point objective (RPO) and Zero recovery time objective (RTO);
receive a primary-side operation (first Op) at the primary storage site from a client;
send a message to a dependent graph manager (DGM) to first acquire a local DGM lock for a first index node (inode) for the first Op on the primary storage site to ensure that metadata and data on the same first inode are serialized, thus preventing data corruption;
execute the first Op for the inode of a file system of the primary storage site;
replicate the first Op to the secondary storage site;
acquire a DGM lock for a second inode of the secondary storage site to ensure that metadata and data on the same second inode are serialized, thus preventing data corruption; and
execute the first Op for the inode of a file system of the secondary storage site unless a conflict is detected with a second op that causes the first op to suspend on the secondary storage site.

16. The distributed storage system of claim 15, wherein the instructions further cause the one or more processing resources to:
wake up the first Op after a conflicting second Op completes.

17. The distributed storage system of claim 16, wherein the instructions further cause the one or more processing resources to:
execute the first Op on a file system of the secondary storage site.

18. The distributed storage system of claim 17, wherein the instructions further cause the one or more processing resources to:
after execution, release the DGM lock on the inode of the secondary storage site.

19. The distributed storage system of claim 16, wherein the instructions further cause the one or more processing resources to:
release the DGM lock on the inode on the primary storage site before responding to the client.

20. The distributed storage system of claim 16, wherein the instructions further cause the one or more processing resources to:
suspend the first Op on the primary storage site or on the secondary storage site if a conflicting operation is in progress.

21. A computer-implemented method for a delegation process comprising:
establishing bi-directional synchronous replication between one or more members of a first consistency group (CG1) of a primary storage site and one or more members of a second consistency group (CG2) of a secondary storage site with each storage site having concurrent read/write access for serving inflight input/output (I/O) operations while maintaining zero recovery point objective (RPO) and Zero recovery time objective (RTO);
initiating acquiring, with a primary sequencer of the primary storage site, delegation to a range for a first write Op;
acquiring, with an overlap write manager (OWM), a range lock for the first write Op that is accessing the range;
determining that a local delegation on the primary storage site is available for the first write Op when no conflicting Op operates on same range as the first write Op; and
writing the first write Op on the primary storage site, wherein the primary sequencer grants and revokes delegation to any range for the primary storage site and the secondary storage site while a secondary sequencer of the secondary storage site requests delegation from the primary storage site, wherein the delegation to the range for the first write Op expire automatically once a replication relationship between the CG1 and CG2 is Out-of-Sync (OOS).

22. The computer-implemented method of claim 21, wherein the primary sequencer of the primary storage site and the secondary sequencer of the secondary storage site both store granted delegations and process Ops locally until a delegation is revoked by the primary storage site.

23. The computer-implemented method of claim 21, wherein the primary sequencer revokes a delegation when receiving a local request that is dependent on an existing granted delegation to the secondary storage site.

24. The computer-implemented method of claim 21, wherein delegations expire automatically once a bi-directional synchronous replication relationship between CG1 and CG2 is Out-of-Sync (OOS).

25. The computer-implemented method of claim 21, further comprising:
initiating acquiring, with the secondary sequencer, delegation for a second write Op;
acquiring, with an overlap write manager (OWM), a byte range lock for the second write Op;
determining that a local delegation on the secondary storage site is not available for the second write Op based on the conflicting first write Op that is operating on same range as the second write Op;
queueing the second write Op on the secondary storage site;
sending a revoke delegation request from the secondary storage site to the primary sequencer to revoke delegation for the second write Op; and
revoking delegation for the second write Op.

26. The computer-implemented method of claim 25, further comprising:
sending a message to the overlap write manager to acquire a range lock for the second write Op;
detecting that the first write Op has a range that conflicts with a range of the second write Op;
queueing, the revoke delegation request for the second write Op;
upon completing the writing of the first write Op, processing a queued entry for the revoke delegation request;
resuming processing for the revoke delegation request for the second write Op; and
determining no conflicting inflight Ops for the second write Op.

27. The computer-implemented method of claim 26, further comprising:
resetting a delegation range for the second write Op at the primary storage site;
sending a delegation success message from the primary sequencer to the secondary sequencer for the second write Op;
resuming acquiring delegation for the second write Op;
setting a delegation range for the second write Op; and
writing the second write Op on the secondary storage site.
